(19) United States
(12) Patent Application Publication
(10) Pub. No.: US 2022/0075793 A1
(43) Pub. Date: Mar. 10, 2022

(54) Interface Analysis

(71) Applicant: Joni Jezewski, Livermore, CA (US)

(72) Inventor: Joni Jezewski, Livermore, CA (US)

(21) Appl. No.: 17/016,403

(22) Filed: Sep. 10, 2020

(51) Int. Cl. G06F 16/25; G06F 16/245

(52) U.S. Cl. CPC G06F 16/254; G06F 16/258; G06F 16/245

(57) ABSTRACT

This invention translates input information (such as a data set, API, or document) into a format that is interface-compliant (meaningful/explanatory/descriptive/generative/predictive), returning output (such as insights, patterns, functions, definitions, meaning, cause, structure, etc), according to a supported interface analysis intent that was input by the user or derived.

### FIELD

Embodiments of the disclosure relate to interface analysis for extracting formatted information (like solutions, functions, meaning, & insights) from input information.

### BACKGROUND OF THE INVENTION

Analysis logic is usually done manually, without structure applied that would enable automation of the analysis.

Any prior art relating to methods of applying analysis logic automatically would be possible outputs of this invention, as this invention includes logic executed on interfaces (interfaces as defined in application Ser. No. 16/887,411 as a information-filtering standard/format where cross-system change occurs)—which can include logic such as applying an interface standard to information, finding & building logic for an intent, or apply structures to information operations (which enables analysis automation)—to fulfill the input intent task on the input information.

### BRIEF SUMMARY OF THE INVENTION

One or more embodiments of the present disclosure may specify a method applied by the logic of process 400 of the application Ser. No. 16/887,411 submitted on May 29, 1920:

Note: a more readable version of this document with indentation is here:

https://github.com/outdreamer/build-a-cure/blob/master/docs/tasks/interface_specific_analysis.py

General interface analysis process includes general logic (to standardize information to a format to find relevant components to the information) like:
1. convert input information to an interface based on interface object definition (remove information unrelated to dependencies for the causal interface)
2. apply an interface to input information (find core causal interface components (like structures, such as directions of dependency) in the input information necessary to do other causal interface operations)
3. apply interface components to distort information to generate additional information to match (distort input information with causal or other interface components)
   specific interface components (like navigation functions) for that interface
   core/common components (like distortion functions) of that interface
   related components of the interface
   other interfaces/interface operations
4. find matching objects (check formatted information & distorted information for objects that match the causal interface objects
5. convert to input information format (integrate causal structures found with the input information, checking for validity of the structures & their related objects once integrated with the input information)

General interface traversal process includes general logic (to automate structural information tasks) like (as indicated in FIG. 22):
1. obtaining a request (comprising information & intent, and optionally query configuration) from a program or user
2. retrieving an interface definition
3. deriving the interface definition if not found
4. determining relevant interfaces or interface structures
5. determining an interface query structure to organize relevant interfaces or interface structures
6. executing the interface query, checking for information needed after each interface or interface structure traversal
7. applying the interface definition to standardize the information, and finding matching information & interface components, executing the interface analysis steps of the previous paragraph.
8. integrating output into a structure relevant to the interface traversal intent (on the meaning or interface-interface), interface traversal intents such as ‘find a cause of this variable’ or ‘find an optimal structure for this information’, which involves applying structure to the output information as designated in the initial interface query design

The object and advantages of the embodiments will be realized and achieved at least by the elements, features, and combinations particularly pointed out in the claims.

It is to be understood that both the foregoing general description and the following detailed description are merely examples and explanatory and are not restrictive.

### BRIEF DESCRIPTION OF THE DRAWINGS

Example embodiments will be described and explained with additional specificity and detail through the use of the accompanying drawings.

FIG. 1. ‘User Interface Module’ illustrates a diagram of a user interface that can accept user input about a problem & program configuration.

FIG. 2. Interface Analysis Module 140 is a diagram of example components (such as functions & constants) of a program to automatically apply information formats to achieve an input intent.

FIG. 3. Machine learning system 120 is a diagram of an example wrapper component that would call a machine learning system to predict a variable.

FIG. 4. API finding/calling system 130 is a diagram of an example wrapper component that would call an API finding/calling system to retrieve data.

FIG. 5. ‘Structure Application Function—Apply Function’ illustrates applying a structure to another structure.

FIG. 6. ‘Problem space visualization’ illustrates an example visualization of a problem space.

FIG. 7. ‘Network of related problems’ illustrates an example of a network of related problems.

FIG. 8. ‘Problem Types’ illustrates a set of common problem types formatted as information or structural problems.

FIG. 9. ‘Problem formats, with matching solution formats of problem formats’ illustrates an example of various problem formats & solution formats that match them.

FIG. 10. ‘Problem-solution structure-matching: apply a solution function to a structure containing the problem to find specific solution structures for that problem’ illustrates an example of matching a problem with a solution.

FIG. 11. ‘Finding alternate solution formats that fulfill different metrics’ illustrates an example of selecting a solution format that fulfills a solution metric.

FIG. 12. ‘Network of problem sub-problems, breaking a problem into components problems’ illustrates an example of breaking a problem into a set of sub-problems, which once solved, can be aggregated with a solution-aggregation method as shown.

FIG. 13. ‘Causal structure-matching’ illustrates a method of matching causal structures to a variable set.

FIG. 14. ‘Design Interface Query’ illustrates a method of assembling input information into structural meaning relevant to the input intent, using a structure containing information formats.

FIG. 15. ‘Concept definition network’ illustrates a network of related concepts.

FIG. 16. ‘Alternate definition routes’ illustrates a set of definition routes for a concept.

FIG. 17. ‘Match structure for a definition of a concept’ illustrates matching a structure to a concept.

FIG. 18. ‘Intent-matching’ illustrates matching intent to structure & vice versa.

FIG. 19. ‘Insight path application’ illustrates insight path examples and an example of applying an insight path.

FIG. 20. ‘Interface conversion & matching’ illustrates an example of selecting an interface to traverse.

FIG. 21. ‘Interface & traversal diagram’ illustrates an example of a diagram indicating an example interface, & a diagram indicating which interfaces to traverse in what sequence (forming an interface query).

FIG. 22 is a diagram of a process that describes the general workflow for implementing interface analysis.

FIG. 23 is a diagram of an example usage of the system.

FIG. 24 is a diagram of an example environment in which systems and/or methods, described herein, may be implemented, including interface analysis module 220 in FIG. 22.

FIG. 25 is a diagram of example components of one or more devices of FIG. 22.

### DETAILED DESCRIPTION OF THE INVENTION

As used herein, terms used in claims may include definitions such as:
component: functions/attributes/types/objects/systems
input information: can refer to original information input to the initial interface traversal, or traversal output information that has been converted, enhanced, formatted, or otherwise altered in a prior interface traversal, stored as a possible version of the original input information, and sent as input to another interface traversal
interface: a useful standard for comparison consisting of the filtering object's definition routes, conversion function, core functions, objects, & attributes, and related objects like patterns & metadata specific to the interface
the traversal of an interface implies mapping input information to interface components
interface operation act on interfaces themselves (like application, combination, mapping, or injection of an interface)
function: a set of inputs, a sequential list of rules or rule lists (logic tree) applied to the input set, an output set created by changes to the input set executed by the sequential rule list, optionally including side effects from execution. A function may be formatted in a different way, such as a list of attributes, filters, or a network.
intent: any of an abstract goal with direction, a reason to use something, or an output such as the intended result or an unintended side effect, which can be an abstract priority like fairness, a concrete goal, and can have a starting & ending position.
concept: set of unique objects remaining once objects from other spaces have their context & contradictory attributes removed.
network: standard network graph containing nodes (sometimes called vertices) & linking functions (sometimes called edges), with or without node attributes, function relationship determining function shape, and direction as an indicator of intent or another metric.

The present disclosure relates to the use of interface analysis workflows, standardizing interfaces & custom logic automation for constructing a interface analysis system, enabling the identification of information in the format aligning with the input intent. This system enables the execution of structural information tasks fulfilling supported intents with information found/derived/generated on interfaces once input information is formatted for analysis on that interface. This system can be called by a program implementation solution automation from application Ser. No. 16/887,411, or by another program using this interface analysis program as an API resource, or by a user directly calling the interface analysis program to automate structural information tasks.

Method described in claims includes a general program workflow, from input intent & information to supported output (like a causal relationship, interface-filtered information, or an object definition):
1. obtaining input information from a program or user (like a data set of possibly related variables, or objects in a relational database)
2. retrieving an interface definition
3. deriving the interface definition if not found
4. determining relevant interfaces or interface structures
5. determining an interface query structure to organize relevant interfaces or interface structures
6. execute query, checking for information needed after each interface or interface structure traversal
7. applying the interface definition to standardize the information to the interface format, which involves:
   7.A. applying default components or prioritized structures to format or otherwise alter the information to identify its structural relevance to that interface
      default components or prioritized structures can include:
      specific interface components (like navigation functions) for that interface
      core/common components (like distortion functions) of that interface
      related components of the interface
      other interfaces/interface operations
      for example:
      once a data set is converted to the information interface format, like:
      an information-interface structure indicating information position/distribution/identity across agents
      a structural-interface structure like a language network
      a system-interface structure like the interaction of two information systems (with different internal functions/attributes/objects and/or information, like two type clusters in a data set) in a host system
      a math-interface graph of data points on various dimension sets
      the analysis program may follow that conversion with an additional conversion to a format amenable for comparison with important components on the information interface, like:
      core info objects (like a core differentiating/comparison/storage rule, core conversion/filtering/organization function for new information, or a constant fact as a core information unit)
      primary info objects (like perspectives/insights/questions/etc)
      for example, the structure of a question in its default format might be a structure indicating missing information (the important object of the ‘question’ definition) for an intent
      in a graph format, this core ‘missing information’ structure of the question info object could take the form of structures in the graph like:
      mismatches (like an incomplete rule set missing a function/variable attribute/object)
      assumptions (questions being the removal of an assumption, the missing information being how the graph would change if the assumption was removed)
      randomness (missing relevance/dependency to the system, like a data set having outliers that are missing the information of relationship to the data set)
      which could indicate several embedded questions given these question type sub-structures:
      which are the independent/dependent variables?
      what is the independent/dependent variable relationship?
      what do the clusters mean? (group membership of a data record)
      what are the patterns of the clusters?
      what is the probability of various given/generated data points being in a cluster?
      what causes the outliers? (randomness, group resolution/dissolution/merging/divergence/adaptation/misidentification)
      what function describes each clusters' variation? (function relating variables in data set)
      what functions relate the clusters? (how could you transform one cluster to the other)
      what direction or other structures of causation exist between the clusters? (does one group tend to become the other, and why/how/in what contexts)
      as another example, once a data set is converted to the system interface format (like a network of objects & functions with attribute shapes like layers), the program would follow that by converting it to a format amenable for comparison with primary interface objects (like incentives), functions (like optimize), or attributes (like complexity).
      a format that enables comparison with interface objects like incentives would attach labels & structures where known interface structures (or calculated probably interactive/relevant alternative/adjacent interface structures using core combination analysis) are found
      for example, if incentives have a structure like ‘a shape where resources would stabilize at rest’, a related structure would be generatable with core combination analysis by applying core functions like ‘condition where other system variables are simultaneously changing’ instead of the ‘condition where other system variables are unchanging (at rest)’ to generate an adjacent structures like ‘a shape where resources are constant regardless of other variables’, which may be a ‘constant’ or ‘assumption’ object
      if the data set has a structure matching the ‘constant’ or ‘assumption’ object definition the program just generated by applying core distortions to the system ‘incentive’ object definition, it may be comparable with the ‘incentive’ definition object, because those objects are adjacent and operate on similar interaction layers, and may even interact (the program would query for insights or functions to check).
   7.B. identifying matching components between information & interface components (components like systems, objects, functions, attributes, & types)
      A. then the input information objects (converted to the interface) would be compared to interface components, to find matching structures
      B. after this initial match check, the function interface is applied, using interface-specific functions, which are either:
      functions of that interface (function types like core/common/interactive/relevant/change/causative/generative/other prioritized distortion function types)
      functions of other interfaces
      patterns & functions across interfaces (apply the pattern interface)
      insights & insight paths (apply the insight interface, a sub-interface of the information interface)
      functions to achieve core/common/current interface intents, like core/common formats like ‘minimized’, attributes like a ‘change-handling’ priority, or other outputs like core/common/generative functions (apply the intent interface)
      functions of cause/change/potential (apply change/cause/potential interfaces, to ensure youre checking versions of the structure that are probably relevant by commonness or other core priorities like causative change types, causal adjacence, or probability)
      functions of concepts (apply concept interface, to identify concept structures)
      functions of systems (apply the system interface & its components, like the ‘optimize’ function)
   C.A. once these functions are applied, iterate through distortion sets producing different states of the input information:
      verify that the distortions are still relevant to the interface
      repeat the matching process, looking for matching structures between the newly distorted input information structures & the interface components
      for example, once youve applied an insight like ‘comparison is quicker if you only compare different attributes’, which involves reducing the attributes of the input information to the different attributes, do you find any new matches with interface objects, like a match with a function that could produce those differences, from either point in a compared pair as the input & the other point in the compared pair as the output?
      if so, this is a function that you might not have found as quickly if you were matching the object having those attributes on a different interaction layer, like how comparing two shapes would benefit from different functions than comparing two generative functions of the two shapes
   C.B. optionally, distortion functions can be applied with intent to identify new components on the interface (apply an intent distortion function on the cause interface)
   C.C. optionally, distortion functions can be applied to other interface objects, to identify new components on other interfaces (such as applying a causal distortion function to an insight path to check if a new insight path applies, while traversing the cause interface), using the new input information and/or the cause interface objects for comparison
   7.C. convert matching interface components back to input information
      if the program identifies a matching object in step 4 like a pattern (like two variable types that are usually related in a certain way indicated by the pattern) found in the input information, apply that pattern to the input information
      this means:
      retrieving functions/attributes/objects of that matching pattern (like which variable types are applicable), as well as relationships of that pattern to related objects (like related patterns/insights/functions, such as a validation function to check variable type)
      iterating through those related components and/or component sets of the matching pattern from the interface
      applying each related component or component set to the original input information (does this variable pair have the pattern implied by their variable types, which are applicable for that pattern)
      testing the new state of the input information for validity
      does that pattern make sense (does it match functions/outputs or other structures) or have meaning (does it interact with relevant structures), given the system context of other input information or other information generated by prior interface analysis)
      if the probability of an accurate match is high enough, store that matching interface component, formatted to fit the input information, as a possible version of the input information, on which other interface analysis can be applied sequentially
   7.D. repeat steps 7.A-7.C if the selected interface analysis intent (support intents of interface analysis including ‘traversing the interface’ or ‘formatting input information in as many ways as possible’ or ‘filling out an interface definition’) is not complete.
8. integrating output into a structure relevant to the requested intent (on the meaning or interface-interface), which involves applying structure to the output information as designated in the interface query design

One or more example embodiments are explained with reference to the accompanying drawings.

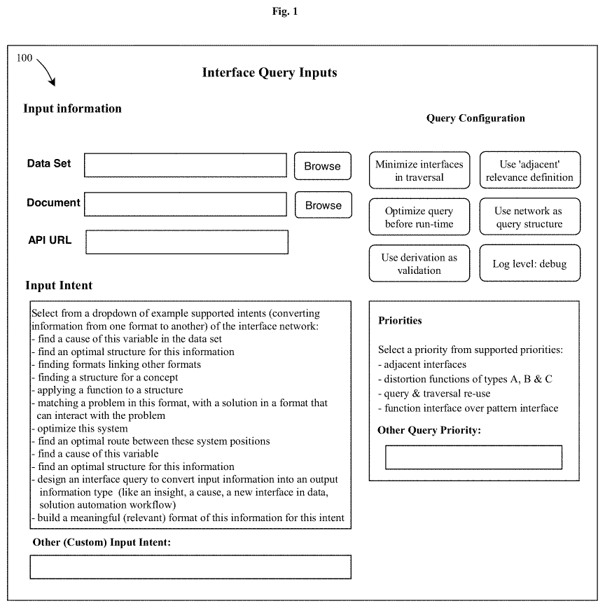

As shown in FIG. 1, and by reference number 110, the interface analysis module 140 may include a user interaction module 110 that may include any device or system or components thereof configured to receive user input and/or provide information to the user. For example, the user interaction module 110 may present an input to enter the intent of the interface analysis, an input for submitting information (a particular data set, document, or API), and inputs to configure the interface query, such as query priority & optimizations.

In some embodiments, user input may vary, such as where the input intent may be a custom intent which the system will attempt to translate into a structure of supported intents, or a selected supported intent. The output may be incomplete or otherwise sub-optimal, in which case the user can state the intent differently or add/format information differently, or re-configure the query.

The input validation will return a message if the program cannot correct the input information, configuration or intent, or may return a validation question to prompt the user to enter additional or updated information.

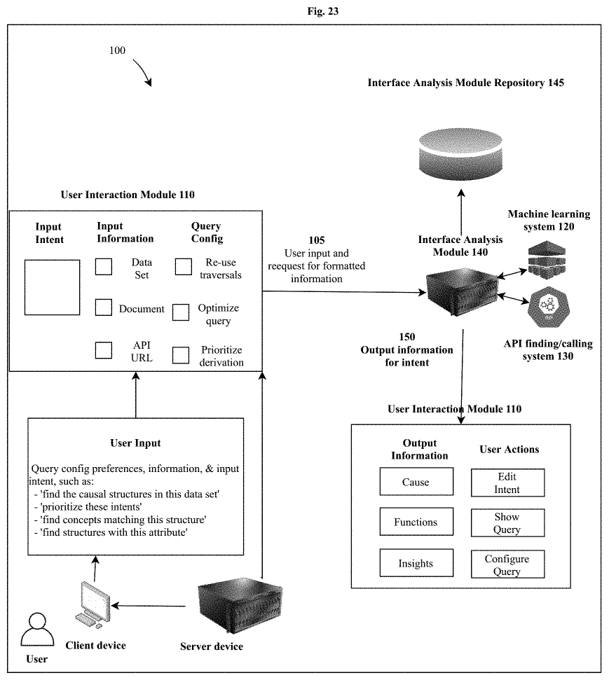

FIG. 1 illustrates a diagram depicting one embodiment of a component of the interface analysis module 140 of FIG. 23, the User Interface Module 110. Information displayed in the User Interface Module 110 may include structures from any of the other diagrams, given that the output sent to the User Interface Module 110 optionally includes query information about the processes run to generate the relevant output information 150.

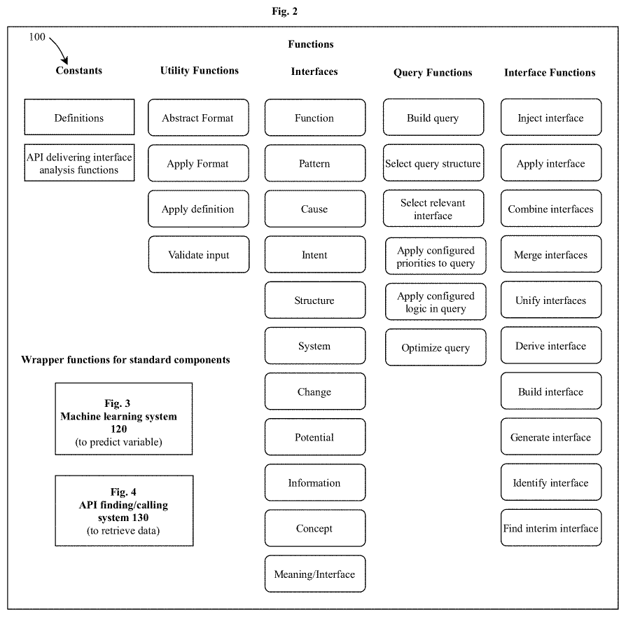

As shown in FIG. 2, and by reference number 140, the interface analysis module 140 may be used to automate formatting/filtering output information for an input intent task & information, in accordance with one or more embodiments of the present disclosure. The interface analysis module 140 may include a user interaction module 110 and a machine learning system 120 and an API finding & calling system 130 that may provide input to a interface analysis module 140. The interface analysis module 140 may facilitate determination of the output information 150 associated with the input intent, and return the output information 150 to the user interaction module 110.

In some embodiments, such interface analysis may lead to output information for the intent, such as the cause of a variable, a set of recommended steps, or a list of organized priorities. In these and other embodiments, if a user is dissatisfied with the provided output information 150 (e.g., the information is incomplete or no information was found), the user may interact with the interface analysis module 140 (e.g., to add more information or remove assumptions) and the interface analysis may be run again.

The interface analysis module 140 may include any device or system or components thereof configured to utilize the inputs from the machine learning system 120 to predict a variable or the API finding & calling system 130 to find data like definitions, data sets, & insights, and from the user interaction module 110 to output the output information 150.

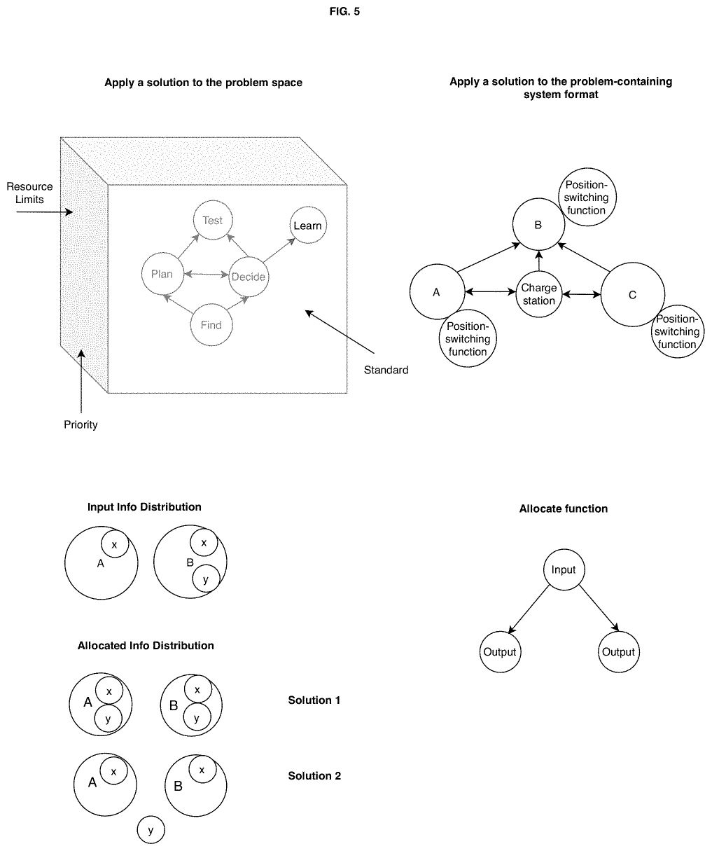

As shown in FIG. 3, and by reference number 120, the interface analysis module 140 may include a machine learning system. In some implementations, the machine learning model, used to predict a variable, may include a supervised machine learning model (e.g., a decision tree learning model, a learning classifier systems model, a nearest neighbor model, a support vector machine model, and/or the like), an unsupervised machine learning model (e.g., a clustering model, a neural network model, a latent variable model, and/or the like), or a combination of the aforementioned, described elsewhere herein.

The machine learning system 120 may include any machine learning system configured to identify relationships and/or correlations from a data set. For example, the machine learning system 120 may be configured to identify a set of most likely factors contributing to a format mismatch or missing information.

In these and other embodiments, the machine learning system 120 may provide the correlations and/or the factors contributing to an input to the user interaction module 110 and/or the interface analysis module 140.

In some embodiments, the machine learning system 120 may operate using any machine learning technique or deep learning technique, such as decision tree learning, association rule learning, clustering, reinforcement learning, representation learning, genetic algorithms, etc. In some embodiments, the machine learning system 120 may be utilized to perform a task, such as providing a recommendation of input filters to show in the user interface module 110 based on previous queries of the interface analysis module 140.

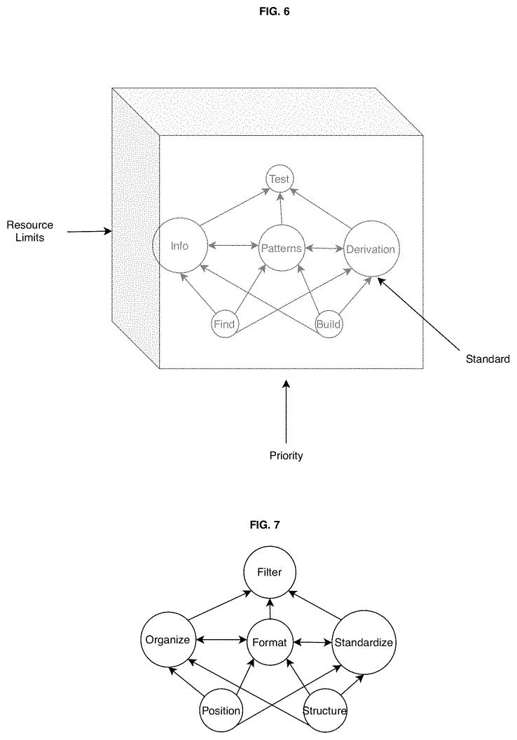

As shown in FIG. 4, and by reference number 130, the interface analysis module 140 may include an API finding/calling system.

In some embodiments, the user may want to use alternate data sources for the definitions & object metadata, or use data sources rather than deriving information, in which case API finding/calling functionality will be executed to discover public or permitted data sources matching target objects, or the data can be generated (or the definition predicted) using a standard machine learning model. Similarly these standard methods can be used to retrieve or generate the latest implementation or pre-computations for a solution or utility function (like sorting or indexing algorithms or testing tools), when local assets are compromised or when the user sets a preference for crowd-sourced or new tools.

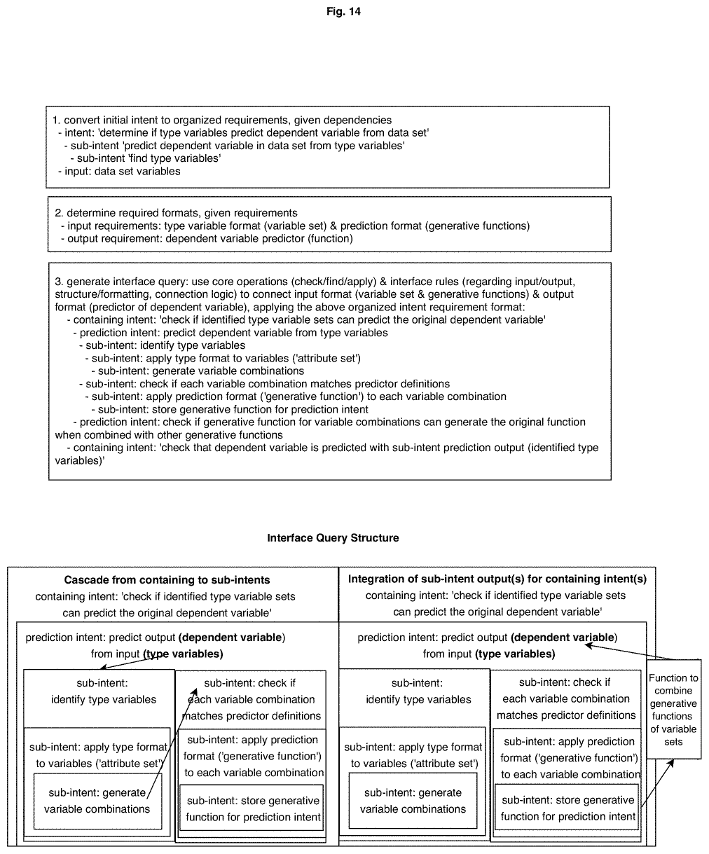

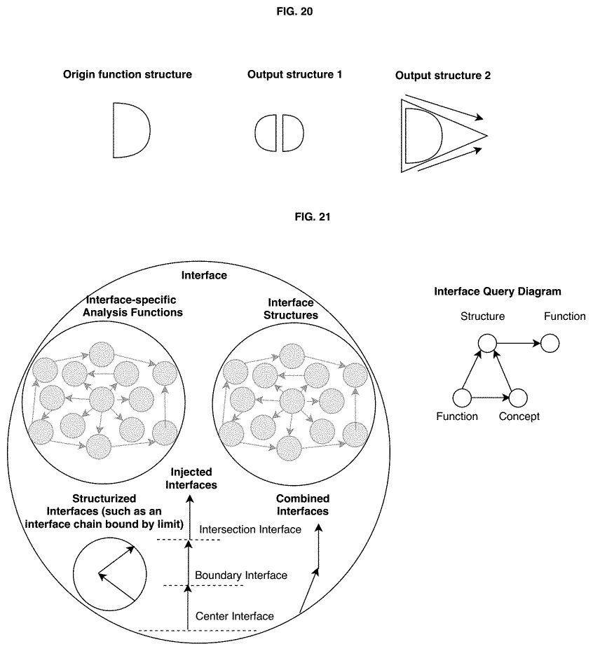

Method described in claims includes interface analysis mentioned as a component of interface analysis module 140 (optionally including example logic & output depicted in diagrams FIGS. 20 & 21), with an example definition of the analysis as follows:
example of the analysis for this interface:
   interface: a filter/standard for comparison of specific attribute(s)
      interfaces evolve when a unifying attribute (priority, cause, structure) can frame a set of developing variance
      interfaces, standards, & perspectives can all be formatted as filters
         an interface can be specific but on the general interface network, it offers a standard for multiple related attributes or causative attributes (types/intents/patterns offer a way to interact with all layers of a system), whereas a perspective is focused on a very restricted set of variables, with the intention of distorting reality to highlight information that other perspectives dont make clear.
   each interface's definition has a specific:
      conversion (filter) function to convert input information to that interface (or a combination or other structure of interfaces), and convert retrieved/generated information back to the input format
      component traversal function (to execute after after conversion)
      a function (and corresponding data, like definitions or interface structures) to find/generate/derive the interface network from that interface, in case resources are isolated
   each interface may have related interface objects, like supported intents
   interface traversal & queries have supported intents such as:
      ‘finding formats linking other formats’
      ‘finding a structure for a concept’
      ‘applying a function to a structure’
      ‘match a problem in this format, with a solution (in a format that can interact with the problem)’
      ‘optimize this system’
      ‘find an optimal route between these system positions’
      ‘find a cause of this variable’
      ‘find an optimal structure for this information’
      ‘design an interface query to convert input information into an output information type (like an insight, a cause, a new interface in data, problem-solving automation workflow)’
      ‘assemble a meaningful (relevant) format of this information for this intent’
objects:
   structurized interfaces: interfaces with other interface components applied (like limits applied to the causal interface components)
   interface operation (combine interfaces, etc)
   interface traversal (apply an interface to a problem)
   interface query (cross multiple interfaces in a sequence)
   workflow: a particular interface query or traversal to solve a problem or problem type, as defined in application Ser. No. 16/887,411
      an example of a problem-solving automation workflow is shown in application Ser. No. 16/887,411 FIGS. 1F-1I and referenced in this application's FIG. 14 (Design Interface Query).
      the default problem type of an interface traversal is ‘find matching components between input information & this interface’
   workflow operation: an interface traversal that selects a problem-solving automation workflow
   the interface-interface where interface analysis is executed (the meta-interface or meaning interface) uses the core functions that can generate the general interface network (filter/find/identify, apply/combine, build/fill, derive/predict, change/transform/process)
structures:
   interface network: the set of networks that act as useful filters/standards for applying structure to organize information
      the abstract interface network optionally includes layers of network filters (intent, perspective, function (can optionally include patterns, logic, strategies, core functions, and any other set of operations/objects that has order), structure, concept, information (organization, formats, types, info objects like problems/questions/insights/assumptions), potential, change, cause system)
      it can refer to a specific interface set for a specific problem space
         the specific interface network for the debugging code space could be a structure containing filters like: dependencies, logic gaps/order/validity, side effects, types
         these specific interface networks are often implementations of the general interface network with mapped objects:
         dependency interface is a combination of the cause/function interface
         types (data, classes, etc) interface is a subset of the general type interface
         side effects are a subset of the variance interface (gaps in intent & execution, prediction of emergent attributes after nth iterations of combinations or other operations)
concepts:
   perspective (default version of an interface, which implies a different method of calculation, priorities, & focus on different objects)
attributes:
   generatability/common derivable core functions with other interfaces
   information loss
   variance focus (what variance is exaggerated for comparison by this interface)
   position of interface on default interface network (what distortions produce this filter/perspective from unfiltered origin)
answers questions like:
   finding explanatory variables on multiple interfaces
   identifying variance that cant be captured in other interfaces
   building a problem-solving automation workflow
   selecting a problem-solving automation workflow to start with for a particular problem (which is the same as designing an interface query)
   finding the structure of cross-interface interactions, such as:
      finding patterns in ratios between uncertainty generated by a function combination vs. uncertainty-reduction function patterns & potential
      determining the relationship between the function converting one structure into another & the function converting its determining/descriptive/causative/generative variables
      finding valid/invalid change types in a structure
      finding structures fulfilling a concept combination & trajectory to the objects in that structure whose differences are relevant to those concepts
      determining the impact of operations done on one attribute (length) vs. another attribute (angle)
      finding how core operations & objects develop & accrete in a structure (like a system)
      deriving object types with attributes useful for a particular operation (“quaternions for 3-d rotation”)
      converting information objects (like value) into system objects (like units, such as integer units)
      finding patterns that turn into objects that attract/hold the most variance
   how to generate a new solution automation workflow
   what solution automation workflow is optimal for this problem
functions
   interface integration functions
      assemble meaning (relevant cross-system structures) of information retrieved, during & after interface traversal, integrating new information retrieved/generated with input and/or prior information retrieved/generated
         this function integrates output into a structure relevant to the interface query intent (on the interface-interface) which involves applying structure to the integrated output information from the interface traversals, as designated in the interface query design
   interface query functions
      function to apply interface query config (default config or config input by user)
         interface queries can be configured by parameters like:
         priority
         logic allowed in interface query (like exit/return statements or conditions)
         error log level
         optimizations
         preferred interfaces/structures/formats/methods, like:
         query organization methods
         prefer the function interface over the pattern interface, for specificity
         prefer sequential interface queries, for state tracking
         prefer core functions (prefer finding existing information as opposed to deriving information or generating new information)
      function to find/derive/build an interim interface to standardize components from multiple interfaces
      example: changes from other interfaces can all be framed on the interim change interface
      function to determine adjacent/causative/generative/descriptive/alternative interfaces
      function to design an interface query (sequence of traversing interfaces), as shown in FIG. 21 (Interface & traversal diagram)
         As shown in the ‘Interface Query diagram’ section of FIG. 21, an interface query (or the corresponding objects inside an interface, such as an interface traversal indicating a preferred navigation like starting with core/common/generative components) has conditional logic dictating which interfaces to apply with what structures (in which conditions and in what sequence), such as:
         start from system interface
         check for components fitting the object, attribute, & function interfaces (as well as structural interfaces & objects frequently found in systems like symmetries and equivalences),
         apply the insight interface where there is uncertainty and the pattern interface where the insight interface cannot reduce uncertainty.
         For example, an actual interface traversal does matching logic such as:
         once you have formatted a problem as a system, iterate through objects, attributes, & functions in the problem system
         check for anything in the problem system that looks like a system object, such as a false similarity, an incentive, or an efficiency, with a particular focus on system objects that are associated with the problem type (if there are any insights relating that problem type with system objects such as imbalances relating to the info asymmetry problem type).
         As shown in the ‘Interface’ section of FIG. 21, example structures found in an interface are depicted, including injected interfaces, core interface structures, interface-specific analysis functions, etc.
      this function assembles a structure (like sequence or network) of interfaces or interface structures (like a combination) that can fulfill a user intent (the user optionally being a program requesting an interface traversal or query)
      core functions (filter, find, apply, derive, build, change) mapped to user intents (identify cause, predict a variable, build a function) can generate & design a query on the interface network
      function to select a structure (like a network or sequence) to organize an interface query, containing interfaces to traverse
         if not a sequential query, another format like a network interface query may contain conditions to assess after each traversal, such as:
         whether to apply/inject an interface if a minimum of information retrieved is not reached
         whether to exit processing and return output to the user if information fulfilling a certain metric like ‘explanatory potential’ is found
         the interface query may apply interface operations to determine interface application structure like sequence or network
      function to find an interface, interface structure, or interface traversal to fulfill an intent
         this function finds a structure of information formats/standards that would be useful for a given input intent, and selects the interfaces that could produce that structure of formats
         this function identifies when a particular specific interface will reduce solution set across any possible host system
         examples:
         the filter interface is more clearly usable as a method to generate the others be most problems can be reduced to a structure that can be filled in different ways for different reasons
         it can even generate the change interface, by framing each process as a filter between i/o
         framing a conflict of type ‘competition’ as opposing direction/intent or equivalent direction/intent is a calculation that can be automated using any of these kinds of analysis, but the logic & intent interfaces are best at this, and selecting those type of analysis is an important tool to build
         which interface to standardize to in what structure (sequence/combination) depends on which use you intend to use the information for
         if you need to implement it immediately, an interface like intent that is semantically adjacent to the structural & logical interfaces will be more useful
         if you need to identify new types, standardizing to the type interface will be more useful
         example interface queries for problem statements:
         https://github.com/outdreamer/build-a-cure/blob/52c3461fdd3ff38284b63f8c2e71542f415d88d9/docs/specific_methods/problem_solving_matching.md
         problem: find a prediction function to predict variables causing an output, like predicting stock price or a diagnosis from symptoms/causative conditions
         interface traversal
         find information (describing variable types, redundancies, missing info, etc)
         fit system (fitting the variables to a system format)
         map cause (finding root/direct causes & causal structures)
         match concept (whether the problem is valid given a definition of price)
         identify change (how the function can change)
         if thats not enough to fulfill solution metrics or reduce the problem (identify a range of possible prediction functions), traversals with interface operations can be done
         causal*change*pattern—to examine whether causal change patterns can reduce the problem or identify a solution
         concept*change*causes—to identify if a concept change looks imminent
         problem: find & build an optimal invention design to fulfill intents like ‘building a function with minimal bugs’
         interface traversal
         find information (describing function intents, limits, and assumptions like parameters)
         fit system (fitting the function to a system, formatted to optionally include possible variance injection points, identify efficiencies like logic that can be merged, etc)
         identify structure (identifying structures that can be applied to the function system, like filters (conditions), direction changes (control flow statements), relationships (assignments), and mismatches (errors)
         identify potential (identifying unenforced rules, rule-intent imbalances, false similarities, & other objects of potential allowing exploit opportunities that are not already identified)
         change cause, intent, concept (test function impact on other causes, concepts, & intents, which are high-level objects a function can alter)
         match pattern (does this function comply with patterns for functions with similar solution metrics)
         if the function implementation doesn't fulfill solution metrics, other interface traversals can be done
         a system-object or function-concept interface like the ‘efficiency interface’ or ‘ambiguity interface’ (does this function have a more efficient or less ambiguous route between input & output that might fulfill a solution metric, given that maximizing efficiency & reducing ambiguity are standard system & function metrics)
         problem: find an optimal route (or alternatively, find a distribution of functionality/efficiencies/costs to make all routes or a particular route less/equivalently costly) between start & end points, like the ‘minimal trades to get equal problem/opportunity distribution’
         interface traversal
         identify information (identify differentiating attributes/functions/sub-systems of agents/positions/routes within the network)
         fit system (identify relevant structures like abstraction layer to traverse at, identify important objects required to solve the problem, like trading problems/markets/skills/information/risk/bets vs. trading currency, or framing currency as a position attribute, rather than a standardizing interface)
         identify structure (identify trade & other market structures that are important for understanding why resources don't get distributed fairly, like closed trade loops & independence machines)
         identify potential (identify alternative perspectives that could also explain the variation in optimized routes, like alternate value definitions)
         identify cause (identify causes like marketing, collusion, and regulations that prevent or interfere with equilibrium market events)
         identify concept (identify concepts relevant to markets like balance, demand/supply matching, and how the concept of information can disrupt any other market be it enables automation)
         if queries of those interfaces are insufficient to solve the problem, interface operations can be used
         the information-system-structure interface operation (can be used to determine information like the next layer of information objects that are relevant if enough automation is distributed)
         problem: design set-sorting or value-finding function:
         analyze a set object from these interfaces—then when you find a pattern match on an interface set, you can restrict the search to those
         core interface: what core functions determine set generation/selection/aggregation/interaction/organization
         causal interface: what functions were used to generate the set
         intent interface: what is this set for
         structure interface: randomness, endpoints, subsets/split
         potential interface: what are the limits on this set, what is the set of possible outcomes
         change interface: where is the change concentrated/distributed in the set from a standard set
         pattern interface: what patterns do sets in this position (determined by attributes or sample subset) normally follow
         function interface: what functions are adjacent to the set if it has a sequence or clear function map
         concept interface:
         what specific tradeoffs/mismatches/alignments/symmetries/combinations/interactions are inherent to the problem/problem space? (specific concept filter)
         where is the power distributed in the set? (abstract concept filter)
         identified concepts: ‘similarity’ in navigation, ‘equality’ in split=>optimal for target value near initial split points or similar positions to the split points
         system interface: what variance injection points are in the set generation/selection/aggregation/interaction/organization
         key concepts of this problem (like the “tradeoff of search start point/split function/organization vs. performance”, “subset gains”, “pattern matching”, and “potential worst/best case scenario of solution”) should be found quickly from various interfaces:
         structure interface:
         position (sequence in the set problem space) is a determinant of adjacence/distance
         adjacence between start search position and final found value position is a key metric
         start-found adjacence can be maximized by changing input (number of start points)
         limits on number of processes involve ability to read a value at a given position at a time
         maximizing start-found adjacence requires more work (higher search processes) to produce a possible metric “lower search time”
         “search time” and “start point count” have a tradeoff structure
         potential interface:
         the set of possible outcomes (possible positions of value) is equal to the set's positions (indexes)
         how do you reduce the set of possible outcomes if the possible outcomes are an integer sequence equal to the set length
         subsets are a potential interim unit (based on the value count attribute) between the outcome data type (one value index) and the input data type (set)
         the potential of subsets of equivalent length to contain the value could be equally likely (adding randomness to search)
         potential injection point for pattern interface: skipping equivalent valued subsets could reduce solve time (if subsets with a certain split follow patterns as determined at search time)
         best case scenario in standard search (random or endpoint) is the first value in the set is the target value
         does subset search offer gains to random search?
         best case scenario of unit solution type (iterate check of value) in subset search is first value after first subset split (split in half) is the target value
         next best case scenario type (if the unit solution type best case scenario doesn't occur iteratively) is pattern found & used to reduce solution/search space
         splitting requires multiple processes
         pattern logging/searching requires multiple processes
         depending on set, either can reduce solution space with extra work
         there is a trade-off between work invested in pattern-checking, subset-splitting & solution space reduction potential
         interface query logic example, as shown in FIG. 14 Design Interface Query
         FIG. 14 depicts an example of assembling Structural Meaning relevant to an Input Intent, using a structure containing Information Formats.
         For example, to fulfill an intent like ‘determine if type variables are a predictor for this data set’ (where type variables arent included in the data set), this function would organize the relevant interfaces by core operations:
         example of an output interface query in abstracted form (this can be used as a structure to fill with logic, rather than starting from format structure):
         check that:
         variables[independent]/(standardized by)
         [type interface].function.(patterns∥insights) or [attribute interface].function[aggregation](patterns∥insights)
         as an input to [potential interface].[prediction interface].functions (including regression)
         outputs [input information].variable[dependent]

1. As shown in the process depicted in the top half of FIG. 14 for this example, the logic may convert initial intent to organized requirements, given dependencies
intent: ‘determine if type variables predict dependent variable from data set’
sub-intent ‘predict dependent variable in data set from type variables’
   sub-intent ‘find type variables’
input: data set variables

2. As shown in the process depicted in the top half of FIG. 14 for this example, the logic may determine required formats given a set of specific format requirements, out of the full list:
input requirements:
   type variable format:
      variable set
      type attribute
   prediction format:
   function structures: functions formatted as a set of limits/vectors/filters/networks/sequences/sets
   function format types
      function development functions (and their formats)
      generative/descriptive/causative/determining functions (and their formats)
      mixed-certainty function (with points or subsets where non-uniqueness of outputs is introduced to represent a possibility structure like a possible output range)
output requirement:
   dependent variable predictor: function

3. As shown in the process depicted in the top half of FIG. 14 for this example, the logic may generate an interface query:
use core operations (check/find/apply) & interface rules (regarding input/output, structure/formatting, connection logic)
to connect input format (variable set & generative functions) & output format (predictor of dependent variable),
applying the above organized intent requirement format:
   containing intent: ‘check if identified type variable sets can predict the original dependent variable’
   prediction intent: predict dependent variable from type variables
      sub-intent: identify type variables
         sub-intent: apply type format to variables (‘attribute set’)
         sub-intent: generate variable combinations
         sub-intent: check if each variable combination matches predictor definitions
         sub-intent: apply prediction format (‘generative function’) to each variable combination
         sub-intent: store generative function for prediction intent
   prediction intent: check if generative function for variable combinations can generate the original function when combined with other generative functions
containing intent: ‘check that dependent variable is predicted with sub-intent prediction output (identified type variables)’

4. The process in the top half of FIG. 14 may also involve determining function requirements, given intent format, with sub-queries to generate/find/derive these functions as needed, before running the above interface query
function: combine variables into sets creating generative functions
function: iterate through variable sets
function: identify variable sets indicating types
(variable sets that could create a generative function that would be combined with other functions to build the original function, like how combining y=2 and y=4 can generate y=3)
function: identify predictive variables
function: identify dependent variable relationship to function components or alternate functions

5. The process in the top half of FIG. 14 may also include iterating through other input format combinations, applying format combinations to organize & connect the available input & output formats
As shown in the bottom half of FIG. 14 in the Interface Query Structure example, the organized intent structure of the logical process above can be visualized with embedded shapes. The intent outputs (starting from the most granular layers) which are then integrated by layer using core operations like combine/filter/apply.
example: here's an example of why different interfaces are more useful in different situations, given a standard problem like ‘build a function automatically for a given function intent’.

https://github.com/outdreamer/build-a-cure/blob/52c3461fdd3ff38284b63f8c2e71542f415d88d9/docs/core_analysis/system_analysis.md

https://github.com/outdreamer/build-a-cure/blob/52c3461fdd3ff38284b63f8c2e71542f415d88d9/docs/core_analysis/interface_analysis.md

https://github.com/outdreamer/build-a-cure/blob/52c3461fdd3ff38284b63f8c2e71542f415d88d9/docs/core_analysic/derivation_methods.md

https://github/com/outdreamer/build-a-cure/blob/52c3461fdd3ff38284b63f8c2e71542f415d88d9/docs/specific_methods/problem_solving_matching.md

1. Intent Interface
If you want to build a function automatically, and you have code indexed by intent, then you don't need to write code, you need to write the intent & sub-intent sequence or other structure. I would call that ‘standardizing to the intent interface’ or ‘applying intent structures’ to the overall function intent, which is the problem definition (‘build a function with this overall intent’). If you already have code indexed by intent, framing a function as a set of intents is trivial. If you don't already have code indexed by intent, the process you use to decompose an overall function intent into a structure of sub-intents is a tool that can be re-used to index existing functions by intent.

2. Information Interface
If the problem can be framed as an information problem, you can query information problem type rules & patterns to solve it automatically. Building a function automatically given an overall intent would mean:
solving a series of information problems like:
   ‘information mismatch’ (object1 doesn't match object2 and it should, so assign object2 to object1)
   ‘conflicting information’ (object1 doesn't match object2 so merge their conflicts)
   ‘required information’ (object1 is required to have this attribute value so assign it)
   ‘missing information’ (object1 is missing this attribute so return False or query for that information or generate it).

3. Cause Interface
If the problem can be framed as a cause problem, then you are querying for causes. Building a function automatically given an overall intent would mean:
   finding the causes of bugs
   finding the causes of different types of logic & structures (like sequences) applied to different types of logic (inherent rules governing logic given the point/definition of logical operations, like ‘an if condition usually precedes a non-if condition’ because the point of an if condition is to test for a case to apply logic, where the logic applied is not another condition)
   finding the causes of functions & function-related objects like side effects, memory usage, optimizations done on other functions, etc
   then you'd compose these causes in a structure that would allow automatic generation of functions from a given intent (first apply logic-related causes to generate a function causing the given function intent, then check for optimization-causes in the generated function & apply optimizations if those causes are found in your generated function structure, then apply tests for bug causes, etc).

4. Structure Interface
If the problem can be framed as a structure problem, then you are querying for structures. Building a function automatically given an overall intent would mean:
   finding structures to standardize functions to (limits, filters, networks of relationships, directed networks of operations)
   finding structures to standardize intents to (directions as priorities or more structural goals, possible usage ranges as intents, abstraction as an indicator of intent (neutral/mathematical functions can be used for anything), using intent as a proxy structure for the concept of permission by organizing information access by intent)
   matching intent & function structures that fulfill the given overall function intent without causing invalidating side effect intents

5. Pattern Interface
If the problem can be framed as a problem of resolving which patterns to combine in what structures (where patterns optionally include abstract/generalized structures (such as variables, variable patterns, input-output path patterns, or type patterns) that resolve to specific logic when converted into information, meaning they're assigned constants), building a function automatically given an overall intent would mean:
   finding which patterns or alternative pattern sets (a variable type relationship pattern, an input-output type trajectory pattern, a logic sequence pattern, an optimization pattern) can generate the required logic when constants (specific information-filled versions of the abstract pattern structure) are applied
      the output of that may be as diverse as an input-output table to handle a variety of use cases observed, a prediction function trained on input-output data, a logical sequence, a code query, an intent sequence, a directed logic network, etc—depending on the patterns used

6. System Interface
If the problem can be framed as a problem of fitting the function to a system, building a function automatically given an overall intent would mean:
   identifying starting & ending position to map intent to structure in the system (get from input start node to output end node)
   identify default & alternative (higher cost, lower step count, etc) paths between start & end node
   identifying system objects like efficiencies, incentives, etc, especially those structures clearly relevant to the default & alternative paths between start & end nodes identified
   applying definitions of those system objects to select the logical step sequence (avoid conflicts, target rewards without side effects, minimize costs, apply symmetries for standardization purposes)
   checking which routes fulfill given function intent

7. Concept Interface
If the problem can be framed as a set of concepts required for the solution (framing the intent in terms of concepts like ‘distribute power evenly’), or if you have conceptual information indexed for code, building a function automatically given an overall intent would mean:
   using conceptual math operations to determine which structure of concepts is most useful for the given intent (if combining ‘power’ and ‘efficiency’ in a ‘sequence’ or ‘balanced’ structure would produce the optimal function for an intent like ‘distribute power evenly’, that is calculatable if you have other functions indexed by conceptual structures, or if you have conceptual math operations accessible to determine what structure of concepts would generate the required concept set, or if you have intent indexed by conceptual structures, or if you can standardize intent & concept to another interface where you have conceptual structures indexed, etc)
   for example if you have functions indexed with conceptual structures like the individual concepts required (power, efficiency, distribution), what operations can be applied to these concepts to create the optimal concept combination (‘distribute power evenly’)—meaning conceptual operations like ‘inject power to distribution structure’, ‘limit distribution structure with power injected by efficiency’, etc.
   these conceptual operations involve finding matching structures across the concept definitions:
   ‘injecting’ power into a structure manifesting the ‘distribution’ concept is possible if the distribution-manifesting structure has an input opportunity of some structure, and power can be translated into a structure that can be used by the structure having that input opportunity (a distribution structure such as a function having an input opportunity in the form of a parameter, where power can be translated into a usable structure like information assigned to that parameter), given the definition of the ‘inject’ operation as ‘input the injectable to the receiver’
   you can avoid doing structural operations by storing the structures for each concept and then storing patterns/outputs of their operations
   if combining power & efficiency produces a structure set, that can be derived by querying the structures of power & efficiency and combining those structures in a way that doesn't invalidate either definition
   you can also apply logic to the concept operation (‘inject power to distribution, limited by efficiency’) to create the output concept of that conceptual operation (‘efficient distribution of power’), and then do a structure query of that output concept
   once you have function structures matching the output (having found function logic matching ‘efficient distribution of power’ once translated to the structural version ‘minimized cost of allocating inputs’ if inputs are the structure found in the function system matching the power definition, where ‘minimized cost of allocating inputs’ can mean ‘diversifying calls for this intent across various alternative functions’ or ‘re-using existing functions where possible to minimize the cost of building a function on-demand or at compile time’ or ‘a function set that minimizes the memory/space requirements of allocating inputs’), you check if those structures optimally fulfill this function's intent, ‘distribute power evenly’, and then execute the final steps to resolve those structures into function logic (with input-output requirement chains, intent-matching, etc)

8. Problem Interface
If the problem can be framed as a problem in a problem network of related problems, and/or a problem space, you can calculate attributes like whether the problem is about to be invalidated by other functions built for other problems, whether the profit opportunity of solving the problem is worth the probable cost, whether the whole problem space is about to fundamentally change, etc. Building a function automatically given an overall intent would mean:
   determining whether the problem of organizing logic is a solved problem if framed differently (can AI generate code with enough accuracy to invalidate further investment)
   determining whether solving an adjacent or proxy problem invalidates solving this specific problem (can concept or intent identification tools or even existing code bases invalidate the need for a tool to build functions automatically, or can code bases be re-written in a way that invalidates automatic code generation, by simplifying code-writing to a task of intent-writing or code query-writing or another process simple enough to invalidate complex code and the need to generate it)
      determining if a solution like logic automation can replace code generation (a tool that automatically applies the definition of logic, optionally including all related objects like logical fallacies, to prevent logically ‘jumping to conclusions’ or ‘ignoring assumptions’ or ‘over-applying bias vs. updating bias’, then indexing code as these logical objects so logical rules can be applied to optimize/generate code)
      this would involve writing high-level logic language like ‘find information, avoid misidentifying object1 as object2, combine common attributes of these objects with versioning in case of conflicting values, avoid this conclusion & this fallacy error type’, which would allow logical object definitions (of what a fallacy is, what a legitimate conclusion/assumption/implication is, etc) to be applied automatically, rather than the existing method of applying conditional/contextual/specific low-level logic developer-defined definitions to be applied manually, which involves writing low-level logic like ‘select*from table, check if object1.attribute.value==object1.attribute.value, etc’.
   determining whether the problem can be formatted as a set of solved problems (applying organization to information, applying definitions, finding matching structures, generating tests) or in a format that is solved (route optimization)
given the information you have, one interface may be more useful to standardize to than another. If you already have intent or cause information indexed or otherwise adjacently calculatable, or if those interfaces contain the required solution information (as in, the problem is ‘finding the cause of some measurement’, so the solution is going to be findable on the causal interface), you'd be better off standardizing to those interfaces first, without other information.
function to determine whether to skip adjacent interfaces in interface trajectory
   sometimes you'll be able to skip interim variables/interfaces
      example: depict the spine variable & the finger position variable to demonstrate/identify chirality, skipping the connecting functions, because there are multiple connecting functions (endpoint/side selection, extremity development) and they dont determine change in either variable, as the key important relationship is the spine symmetry and the orientation transformed about the finger position interface being reversed according to the spine symmetry
         the spine isnt symmetric from the side, which implies a bias toward the front, which is a platform where features are concentrated, so the development of limbs (using derivable intents like duplicate, backups, protective, flexible, movement, alternative, balance intents) & their focus toward the front is derivable from the spine features, so we can skip to the finger order interface to identify the concept of chirality or an example of it/its patterns in the system
      the interim interfaces & variables may not add change to this relationship so they dont need to be depicted or stored in this context
      this is useful for determining where change can be stored/routed in a system
         if there is demand for change (stressors demanding new functionality) but all components but one are maximizing their change handlers, then you know theres one potential variable where change will gather/be routed, if its possible to route change from the variance injection point to that variable's causal stack at some layer/point
      its also useful for determining interface trajectories/adjacent interfaces
interface traversal functions
   function to design an (internal) interface traversal:
      this function allocates interface structures (like priorities/dependencies/conditions) to form a structure (like a network or sequence) containing operations applying:
         specific interface components (like navigation functions) for that interface
         core/common components (like distortion functions) of that interface
         related components of the interface
         other interfaces/interface operations
      in order to form an (internal) interface traversal query, similar to the function that designs an (external) cross-interface query structure (like a sequence or network) containing interfaces to apply with connecting logic
   determining position/trajectory on interface
      starting from a particular object layer on an interface (like how info attributes like measurability are on one layer, and info objects like questions are on another layer)
function to traverse an interface:

1. convert to interface based on definition

2. apply an interface to input information

3. apply interface components to distort information to generate additional information to match
specific interface components (like navigation functions) for that interface
core/common components (like distortion functions) of that interface
related components of the interface
other interfaces/interface operations

4. find matching objects

5. convert to original system format)
this function implements traversal by applying interface components (like functions/attributes/objects) of a certain type (like core/common) in a structure (like a sequence) such as:
   applying core/common/generative/cross-system components (like functions) first
   applying insight/intent interface first
      example: applying cause-related insight paths to input information once converted to the cause interface
   applying interface checks first
      example: checking for new interface objects (like change types), if the interface changes frequently (like the change interface)
   applying related objects of the interface:
      example: applying interface info objects like related questions/insights
the function to traverse an interface is referenced here:

https://github.com/outdreamer/build-a-cure/blob/52c3461fdd3ff38284b63f8c2e71542f415d88d9/docs/specific_methods/math_semantic_map.md

https://github.com/outdreamer/build-a-cure/blob/52c3461fdd3ff38284b63f8c2e71542f415d88d9/docs/specific_methods/problem_solving_mathcing.md

https://github.com/outdreamer/build-a-cure/blob/52c3461fdd3ff38284b63f8c2e71542f415d88d9/docs/tasks/function_to_do.md

https://github.com/outdreamer/build-a-cure/blob/52d3461fdd3ff38284b63f8c2e71542f415d88d9/docs/tasks/to_do.md

https://github.com/outdreamer/build-a-cure/blob/52c3461fdd3ff38284b63f8c2e71542f415d88d9/docs/tasks/idea.md

https://github.com/outdreamer/build-a-cure/blob/52c3461fdd3ff38284b63f8c2e71542f415d88d9/README.md
function to find distortions to apply that would generate useful information (example: ‘apply core/interaction layer/generative/causative/primary functions to input information’)
function to identify & find related objects of an interface
function to apply a distortion function from an interface to input information
conversion functions (conversion to an interface format, and conversion back to input information system format)
interface conversion function as shown in FIG. 20 (Interface conversion & matching) example:
   converting objects to the type interface involves identifying attribute sets that are unique, and then identifying types that can describe multiple unique objects as variations of an attribute in the attribute set
   converting to the cause interface involves focusing on dependence objects (inputs/outputs)
   As shown in FIG. 20, the application of a standard interface query (function-structure interface) is depicted for a problem definition such as ‘complete the function based on the implied pattern’.
      The interface query steps to find/derive/generate the ‘completion’ function may include:

1. standardize to structural interface (graph the function)

2. query for implications of the structure (triangle with curvature applied, alternate paths between corners varying on curvature, motion in the direction of concavity, filling a shape similar to existing shape)

3. apply implications (implications of change types indicating prior or next states)

4. result is a triangle or ellipse for various implied change types

5. convert triangle/ellipse to function

6. filter by any specific solution metrics given
Given the origin function structure, the interface query would find rules, implications, & other objects relevant to the structure, such as:
   ‘Copy & rotate a semi-circle to create a circle/ellipse’
   ‘Streamline along tangent (involves standardizing to concept interface) to make triangle’
The origin function structure has been converted from the structure interface to the system interface (including the ‘implication’ object) and back to the structure interface, with system objects like relevant rules of implications applied.
interface-interface functions
find interfaces
   find the pattern interface in the cause interface (used when validating that an interface is completely defined)
   identifying all interfaces with variance that cant be captured in other interfaces
   filter interfaces
      filtering the pattern interface by the intent interface with would produce a set of intents found in patterns
   identifying specific interfaces (filters) for a problem/space
build interfaces
   construct an interface (apply interface definition & generate structures to fill it)
   deriving an interface definition from examples of objects/functions/outputs of that interface or a source of unhandled variation:
      ‘searching for examples of the interface on other interfaces’
      ‘aggregating unhandled variance into the new interface as a potential change type formattable on that interface’,
      ‘filtering examples of an interface into core components, which can be used to generate the examples’
      ‘assuming common core components & patterns for the interface from other interfaces and applying distortion functions until the interface examples can be generated’
   derive the interface network from an interface
      each interface network in the set of interfaces (core function interface network, general interface network, specific interface network) can be used to generate the others
         intent interface can be used to generate the type interface
         dependency interface can be used to generate the side effect interface
         interface network can be used to generate the core function interface
   generating full set of general interfaces (intent, concept, structure)
      these can be generated by identifying the key differentiating factors across systems, which can be generated as combinations of objects
         type is a combination of attributes
         intent is a combination of function effects
         concept is a network of networks describing a structural concept (balance, power)
         structure is a combination of information & rules
combine interfaces:
   combining the pattern & intent interface with combination type ‘group’ would produce patterns grouped with intents
   combining the pattern & intent interface with combination type ‘merge’ would produce merged objects containing attributes common to both patterns & intents
      function to merge interfaces:
         function+pattern interface: merge networks of functions & patterns into one standard interface definition (input/output/logic+metadata of both objects)
   combining the pattern & intent interface with combination type ‘unify’ would produce unified objects like intents distorted by patterns
inject interfaces:
   injecting the pattern interface in the intent interface would produce:
      intent examples & abstractions (applying the definition of ‘pattern’ to include specific & abstract patterns)
apply interfaces
   applying the pattern interface to the intent interface with would produce intent patterns, intent component patterns (intent function patterns), intent interface related object patterns, etc
   function to apply an interface to another interface:
      intent/structure interface: assess intent interface by a standard of structure interface (which structures can simplify the intent interface)
   function to expand an interface by another interface:
      function*pattern interface:
      function patterns (what patterns are there in functions), pattern functions (what functions generate patterns)
      function pattern functions (what functions generate function patterns), pattern function patterns (what patterns are there in functions that generate patterns)
   cause*type interface:
   causal type interface (what types of cause are there), type cause interface (what causes types)
   causal type cause (what causes causal types), type cause type (what types of type causes are there)
examples
   examples of interface queries that function as problem-solving automation workflows

https://github.com/outdreamer/build-a-cure/blob/52c3461fdd3ff38284b63f8c2e71542f415d88d9/docs/specific_methods/problem_solving_matching.md
The following are general examples of a workflow to find a solution to a problem automatically, as described in application Ser. No. 16/887,411.

The process 400 in application Ser. No. 16/887,411 runs interface queries to match a problem with its intended solution information (like a strategy) in the intended solution format (strategy formatted as a set of steps in a problem network or vectors reducing a problem shape)
interface queries to solve a problem can be as simple as a query for specific solutions to re-use solutions in the database, or as complex as applying a format to the problem to make calculating the solution trivial)

Workflow variables optionally include:
starting point of the analysis (which interface the query starts from)
structures relevant (which structures or type of graphing method to use)
intent (create a prediction function, reduce solution space, compare solutions, or match problem with solution)
core abstract function represented (is it a find method, an apply method, a combination)
formats & structures used (object model, interface query)

If the problem is ‘finding a structure that matches conceptual priorities like strength’, that can clearly begin on the concept-structure traversal, if information required for that traversal already exists in the problem definition or derived metadata
concept-structure interface traversal (a multi-interface traversal linking the concept & structure interfaces, so a target concept combination/set/path or target structural attribute can be achieved with structures like filters/limits/functions that adjust the origin structure until it matches the target structural attributes or concepts)
problem-solution interface traversal: sometimes a sufficient solution may be already stored in the solution table (solution being an information object) and the way to solve the problem is formatting it correctly or identifying its type correctly so that solutions for that format or type can be queried & applied as-is, the most basic traversal type
intent interface traversal, which is particularly effective at linking other interfaces (find intents & intent structures that fulfill the ‘strength’ attribute, and structures matching those intents)

Other workflows can be derived given alternate traversals that can generate information (like how causation, information formats, functions, and intent can generate structure information), given existing information.

These workflows can be generated with new interface combinations or interfaces, if each interface in the sequence can add information required to solve the problem. Occasionally an interface will be sufficient on its own, if the problem is already pre-structured. For example, the function interface may be enough to find the right sequence of functions, if the function metadata optionally includes input/outputs and there are no ambiguities to resolve, meaning this solution is a simple query to match inputs/outputs, where the final output is the intended goal of the query

Other problem-solving automation workflows would start with different interface traversals & use different origin & target structures, different target structures like:
a new method to design interface trajectories
new info object layers to use as interfaces/systems (like by combining perspective & potential to generate a potential-perspective field, problems & markets to create a market for problems, platforms & platforms to create a platform to sell platforms, variables & networks to create variable networks, variables & risk to identify variable development sequences)).
structures that, when applied to a problem, create a clear format/structure sequence linking the problem with a solution (like insights such as ‘break a problem into sub-problems & aggregate solutions’ or ‘apply filters until the problem space is a solution space, then repeat until the solution space is a solution’). A specific example is ‘problem vectorization’ as mentioned above in VII: finding specific interim formats linking a problem & solution format (such as the structure of concepts/interfaces that would link variables with a prediction function) & applying structures to create that format sequence (like a directed network)

A problem-solving automation workflow is a type of interface traversal that can be applied to any problem, although some workflows are more adjacent to a problem definition than others, like how a highly structured problem may already have an existing solution in the database, so that workflow of querying the database to find a solution should be applied first. Workflows are very abstract insight paths (a cross-system, insight-generating sequence) detailing specific interface traversals that can generate solutions automatically.

For example, the workflow inherent to this tool (to match a problem with a solution) uses the problem information as the default interface. The overall workflow of this tool can be built with an interface query:
find problem type & format the problem as a combination of information problem types (information (problem, assumption) interface, type interface), as well as any related problems (information (problem) interface, pattern interface, and the change interface to generate related problems if none are logged)
find solution requirements (structure interface where requirements are limits/thresholds)
apply a set of various information formats (interface interface, information interface, structure interface), positioned in the sequence likeliest to find the missing information to solve the problem. For example, if its missing cause information, standardize to the causal interface or generate information about likely causes from other interfaces like the pattern interface or generate adjacent or proxy information to cause information like a set of tests to filter out non-cause information or generate interaction pattern information to predict which objects will interact, generating causes.
if the information formats applied don't reveal enough info, apply combinations of the formats (structure interface, core interface)
if no solution space can be identified or reduced, return the queries and the problem & problem space metadata

Specific workflows to automate problem-solving apply various interfaces & analysis types, and can be applied to any problem with sufficient information in its definition. These workflows optionally include:

I. Filter problem definition until it matches solution structure (using definition & standardization, applying increasing limits/filters/transforms until problem & solution match)
this applies structures such as limits to fulfill solution intents iteratively
for example, when deriving the structural implementation of the concept of cryptocurrency, applying a ‘group’ structure to the ‘transaction’ object creates the ‘transaction ledger’ object, which fulfills sub-intents of the solution (‘access related information’ and ‘connect related information’) and reduces a problem sub-component (the ‘information imbalance’ problem type between receiver & sender), a problem type which has related solution functions (like ‘distribute information evenly’)

II. Solve problem with structure fitting (adapt probable solution structures to match problem definition)
this starts with core, probable, or difference-maximizing structures and applies additional structures until one is found that fulfills solution metrics
for example, to find a prediction function for a data set,
the core functions would be common base/distortion (patterns of change), component (core patterns of prediction functions), approximation (generalizing functions), & adjacent functions (functions within a range of accuracy) of prediction functions
the probable functions would be functions in between the most accurate and the most generalized function versions
the difference-maximizing functions would be the most different possible functions (a circle function to explain a high-randomness data set, multiple step-functions to explain a continuous function, a linear function, etc) to start by examining the most different possibilities and eliminate them with additional filters

III. Transforming problem into query of solved problems (using most adjacent solution formats)
converting the problem into a structure (set, sequence, network) of solved problems (like distributing power, resolving imbalances, etc), and then traversing that structure if multiple alternatives are found
this method can take the form of a simple database query (‘fetch & apply solutions, optionally including insight paths, for this problem type’ or ‘find the fewest question jumps that can solve the problem’) in its most basic form, if the problem is an existing solved problem
for example, finding a prediction function is a set of problems like ‘decide on metrics & threshold values’, ‘decide on complexity’, ‘choose between opposing sides of tradeoffs’, ‘generalize’, ‘identify outliers’, ‘identify noise’, ‘account for error types like corrupt/incorrect/unrecoverable/incentivized or improperly formatted/standardized data’, ‘account for alternate explanations’, ‘account for correlation between independent variables’, ‘account for incorrect data types’, ‘account for missing information’, etc

IV. Solve problem with solution function generation & selection (optionally with pattern/intent-matching)
this uses the function interface to identify useful metrics to select functions to begin with when searching for a function to solve a problem (like ‘calculate x’) which can involve function metadata like identifying hub functions, functions that move in a direction, etc
this analysis involves identifying/deriving decision rules to identify alternate/interchangeable solution functions & select between solution functions
an example would be deciding when to select a solution function you have indexed in the solution table and when to look for a new function, or update the existing function

V. Solve problem with conceptual query (iterate through conceptual paths & match with structural path)
start with required concepts (but not their optimal relationships in a concept combination) such as ‘trust’, ‘distribution’, ‘power’, and find a structure that arranges those concepts in an optimal way that fits the solution requirements

VI. Derive conceptual query & match with structural path
start by finding the concept combination required (‘trust generated from equal distribution of power’), then find matching structures of that specific combination

VII. Vectorize problem/solution space & match intents
this involves framing a problem as a structure like a directed network to convert it to a route optimization problem, where the assumptions are inputs, the intents are outputs, & the interim structures can be a mix of interface objects like concepts
if you have a general problem definition like ‘find a function that calculates x’, you would arrange input information on one side, the function on the other side as the goal, and identify related concepts, patterns, & other objects to that intent to connect them, given the definition routes of those terms
this can also involve formatting the problem as a set of questions (sub-problems of an information asymmetry problem type) to answer that map from starting information to target information

VIII. Mapping variance objects in problem space systems as starting solution space
framing a problem in terms of variance (on the potential interface) makes it clear which objects are important, given variance/potential structures like interaction spaces, inevitable interactions, variance gaps, etc
the high-variance objects in the ‘find a prediction function’ problem are the error types, assumptions, change types, data set concepts (like how the concept of ‘survival skills’ is relevant & inferable in the titanic survival data set), and variation across data sets, so a good solution would integrate functions to identify & handle those objects

IX. System snapshot (interface/symmetry/vertex) derivation
finding the specific interfaces & related objects in a problem system to frame a problem efficiently
in the bio system, this would mean automatically identifying the genetic configuration, protein structure, immune memory, and brain interfaces as important determinants of the system
in a function set like a code base, this would mean automatically identifying the function type interface (to identify function types like boundary/change rules for efficient function indexing) and the intent interface as important for indexing functions
in the ‘find a prediction function’ problem, this would identify the concept of ‘average’ as an important symmetry balancing various tradeoffs, identify independent variable probability distributions as an important vertex in predicting the behavior of dependent variables, and identify the cause interface as an important interface for understanding, which is a proxy for a prediction function, the potential interface as a tool for understanding variable dynamics (how sources of variance gather into variables), and the system interface as a way to derive the range of possible prediction functions (how variables gather in complex systems, and how the range of prediction functions is whichever prediction functions are possible between those variables as system components, given system structure, so you should start with the vertices of that range—meaning a set of difference-maximizing functions in that range)

X. System Derivation
this is a more comprehensive format that allows quick application & identification of system objects (alternates, efficiencies, incentives)
for example, identifying known system objects for the ‘find a prediction function’ problem would mean identifying incentives in data collection (collect small sample, collect representative sample), efficiencies in calculating prediction functions (some sections should be treated as potential fields, where a network is embedded in place of a function section, to indicate decision logic or alternate functions accessible with additional information, if a predicted value is requested from that section of the function), false similarities (like the apparent similarity between two variables being correlation rather than a direct relationship), opposites (like neutralizing variables), and other core system objects

Method described in claims may include information interface analysis mentioned as a component of interface analysis module 140, with an example definition of the analysis as follows:
example of the analysis for this interface:
   information analysis involves:
      info objects are related to agents & their communication:
         perspective, strategy, decisions, intent, game, motivation, problems
      info objects can be defined as combinations of general interface objects:
         game is a system with conflicting/overlapping intents between agents, usually with low-stakes intents
         perspective is a filter produced by chains of distortions
      standardizing information formats, like standardizing to the object/attribute/function model (optionally including related objects like state & type) so that information structures are clear & can be mapped to information problem types
      information formatting (mapping the problem as a structure composed of information problem types, like an information mismatch/inequality/minimum/overflow/gap)
      automatically finding definitions, examples, minimum information to solve, problem-solution matching, insight paths like question-identification functions, generating information objects like insights, finding math structures to re-use math patterns to solve other problems, etc
attributes (structure, format, organization, certainty (potential/future/measurable information))
functions (match, fit, apply, build, derive, define)
objects:
   info objects relate to agents & their communication (perspective, strategy, decision, intent, priority, game, problem)
   these objects can be defined as combinations of general interface objects (object/attribute/type) and core structures/functions/attributes
   problems: sub-optimal state with identifiable problem structures (inequality, inefficiencies, conflicts, mismatches), where the sub-optimal state can be framed as a source-target node in a network, where the solution is the optimal route between them, a vector set to move source-target nodes to change the problem, a vector set to change the format of the problem or convert it to solved problems, a vector set to change the system the problem occupies to remove the problem structure (such as making the route or all routes lower cost, so finding a route is not a problem anymore), a shape that is fillable or reducible with a solution structure (component set or vector set), or a matching solution structure that otherwise invalidates the problem (a recharge/derivation/information function at each node to make each node equally useful)
   questions: source & target node, implying a missing structure of the route connecting them (‘how to get from a to b’, ‘why travel from a to b’)
   insights: newly identified rule between objects
   strategies: insights with an associated context like related intents (‘use this rule to achieve intent x’); efficient paths between points
   patterns: a structure applied to information, where the pattern can refer to the structure or the information filling it
   perspectives: a filter/priority/rule set, optionally having structures like object positions & default rules, produceable with a chain of distortions from a default perspective
   examples: structure applied to a rule in a system, so the rule directly references system objects
   conclusions: resulting output rules or emergent rules from a logical sequence
   assumptions: structures like conditions or constants taken to be true for a particular context, like a particular intent (for the ‘understanding’ intent, assume the condition that the ‘constant is zero’)
   implications: implications are structures implied but not specified by a definition (like how the existence of a floor is implied by the sentence ‘the dog chased the cat’); used for deriving the context of an object—the structures nearby like related intents, the system context an object occupies, etc. Assumptions can be a subset of the implications of an object that are assumed to be true. Both assumptions and implications are pseudo-information that is not definitely true but is potentially true, and treated like true information for a given context like a period of time, during a discussion to learn something, or in the context of executing a function.
   paradox: false illusion of a contradiction that is legitimate, valid, & logical
   argument: position of objects or path between points with supporting connective functions
   game: incentivized motion within a system having limits to prevent motion; a system with conflicting/overlapping intents between agents, usually with low-stakes intents
   joke: difference between expected & actual position
   error: difference between expected & actual outcome
structures:
   asymmetry, imbalance, mismatch, excess, conflict, misalignment, lack, gap
   formats (object format, system format, core format, compressed format)
   these formats can be used to format a function
   filter: barrier creating a difference between input & output (like a filter that allows only a particular data structure through, optionally altering that data structure as it passes through)
   function: sequence of logical steps
   limit: barrier reducing the potential motion of an object (like range of possible values of a variable, or set of variables collected into a type variable), which can be combined with other limits (corner of a shape, sides of a shape)
   set: group of objects (like function components)
   path: sequence of steps, which may be logical or produce logic
   system: a bounded network (the structure of which may produce a function or allow it to develop)
concepts: organization (format)
answers questions like:
   is there a version of this function on the system, and in what format (a compressed/encrypted/generative format)
   what is the sequence of questions that solves this problem this quickest
   what is the network of problem types that this problem can be broken into (optimal transport, creating efficiencies/alignments, distributing costs to points where the costs are inputs, finding a prediction function, etc)
   what is the set of patterns/filters/attributes that can describe this function
   what is an example of this pattern (what form does the pattern take in a given system)
   what would the optimal path be, given a certain intent, object identity, & host system?
   what is the function linking these variables that is most efficient/involves fewest variables/involves known constants?
   identify structures (layer/format) & objects needed to solve a problem
   given a type stack progression, what is the likeliest position or extension of that stack?
   given that these species evolved this way, what level of variance is the missing link between them likely to have?

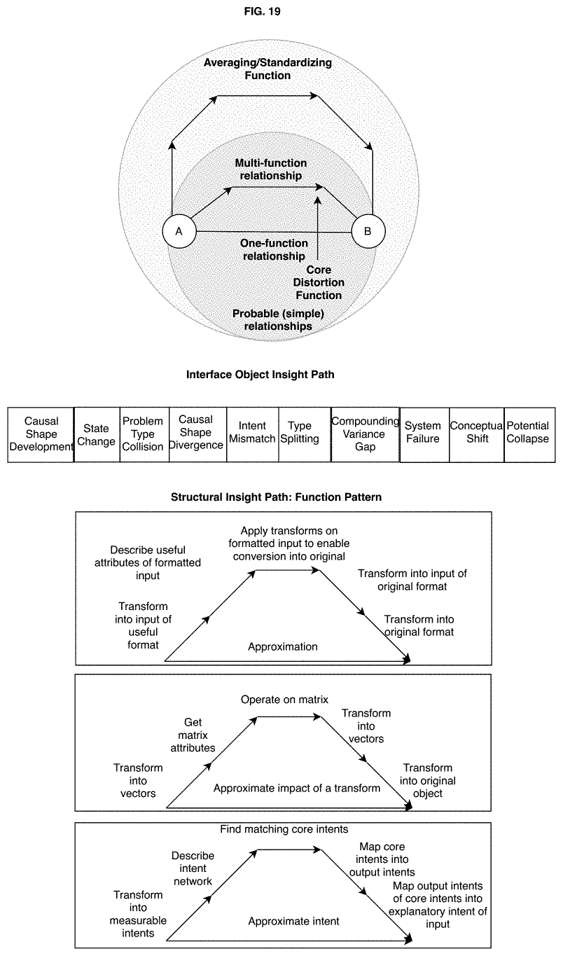

Method described in claims may include insight interface analysis mentioned as a component of interface analysis module 140 (optionally including example logic & output depicted in diagrams FIG. 19), with an example definition of the analysis as follows:
example of the analysis for this interface:
   an insight path is a reusable cross-system pattern, usually built out of core functions from a general interface filter (type, intent, function, structure), that allows generation of insights. It can be as simple as a function like differentiate, a standardizing attribute like relevance, or involve a standard object like a simplifying question. It does not refer to specific strategies unless those strategies can be used to generate insights. Insight paths usually consist of abstract or structural rules like ‘match structure’ or ‘identify type’.
   uses patterns in network structures & insight paths to predict:
      probable missing pieces of networks
      insight path of a route type (optimal/realistic)
      insight path trajectory for a particular assumption set
   attributes: reusability (insights can have a limited opportunity of applicability, and may have scope beyond their host system)
   functions: apply/derive an insight path, shown in FIG. 19 (Insight path application), link insights, identify insight
   units of insight paths include core functions to produce insights, such as:
      change/split/merge type
      change attribute value/set
      apply limit/intent/priority/function/pattern from one part of system to another part of system
      insert interim/sub-system
      insert variance
      insert conflict
      derive common attributes/rules
      combine objects that haven't been combined yet
      check similar objects for common cause or symmetry
      remove/add assumption/requirement/dependency/connection
As shown in the top section of FIG. 19 in the section titled ‘Averaging/Standardizing Function’ depicts example implementation of the function, involving sub-functions to connect input A and output B are depicted, with varying number of steps, usage of core functions, direction, probability & complexity.
Applying an insight path like ‘functions requiring more distortions are less likely’ may automate the assignment of levels of probability to prediction functions, given the ‘Averaging/Standardizing function’ implementation structures depicted.
The section of FIG. 19 titled ‘Interface Object Insight Path’ depicts an example of an insight path that is a trajectory of objects on the interface network, which has some objects in common as the system path because of the cross-over in definitions of a system and an interface. These objects may be object/attributes/rules of an interface (or combinations/other core functions applied to them), maps between interfaces, or filters used to generate an interface.
The section of FIG. 19 titled ‘Structural Insight Path: Function Pattern’ depicts an example structure to frame common distortion patterns as alternate routes from function input to function output, which are a very useful subset of insight paths to generate insights across fields.
objects: rule structure (combination of rules, sequence of rules, position of rules)
structures: insight path
concepts: predictive power (an insight is true & may be powerful in predicting across systems)
answers questions like:
   what rules are useful across systems?
   what rules are derivable given a set of structures that commonly appear in systems?
   what are common rules used for previous insights, and how can they be optimized (shortening an insight path with a set of simplifying/standardizing questions)

Method described in claims includes problem interface analysis mentioned as a component of interface analysis module 140 (optionally including example logic & output depicted in FIGS. 6-12), with an example definition of the analysis as follows:
example of the analysis for this interface:
   on this index, problems are mapped to structure, once problems have been converted to an information problem, which has a clear mapping to the structural interface
   problems can be framed as info problems (missing info, conflicting info, unconnected info, mismatches, imbalances, asymmetries)
   different problem types have different default problem shapes
      example problem type shapes:
         finding a prediction function can be framed as an optimal path in a network of variable nodes
         conflicts can be vectors with different direction or which overlap
         a misalignment problem has at least two vectors differing in direction, where the optimal alignment is calculatable or at least the alignment is clearly improvable
         a variance injection problem has a opening in a closed system
         an asymmetry has an uneven resource distribution
      if a problem has a misalignment problem and a variance injection problem, the problem shape can have both shapes in isolated analysis, or they can be merged, applied, added, mixed, intersecting, or combined in another way
   example solution shape for problem shape:
      for a misalignment problem, the solution shape would be:
         a vector aligning them
         another adjustment to the system that makes the existing misalignment a correct alignment
         a combination of the two
      for a variance injection problem, the solution shape would be:
         an object (resource, function, constant) to close the opening in the system
         an object to prevent further variance injections
      for an asymmetry, the solution shape would be:
         an optimal transport operation set to distribute the resource optimally according to the metric of symmetry
   this analysis involves:
      identifying the given problem & solution target structures in the problem space & the related problem network, so the problem & solution can be visualized
      identifying & anticipating problems in a system, which optionally includes identifying problem structures (inefficiencies, conflicts, etc) that exist or could emerge
         example: in the bio system, DNA regulation functions don't prevent pathogens from injecting DNA or mutations from occurring, so if the program derives the concept of a pathogen or mutation without already having that definition available (using core system analysis), the program could predict that the current DNA regulation functions wouldn't be able to offset the changes exacted by those concepts & the program could predict problems of DNA disregulation in the bio system before they occur
   functions:
      a set of functions to select filters to display in the GUI, and validate input
      mapping function, to map objects to structures, functions, & other object types
         graph an object, like the example problem space visualization depicts a problem space object & problem objects of the problem space in FIG. 6
         FIG. 6 depicts a problem space of building information technology with differentiating attributes like Resource Limits, Standard, & Priority, including problem objects indicating problems (like Finding or Derivation problems) that exist in that space & differ in those attributes.
         graph a related object network (as shown in FIGS. 6-7) & other relevant objects
         FIGS. 6-7 contain a network system relating relevant problem objects.

Problems like info problems, pattern problems, & derivation problems are adjacent (similar) and have similar dependence structures, because they are alternatives, and act as interfaces in the problem network.

The resource limits, priority, and standard generating the problem space of info problems & related problems might be limited derivation technology resources, a priority to find rather than derive information, and a standard information format.

Other variables that can determine the shape of a problem space include other interface objects (a problem generating the problem space, unanswered questions, perspectives, default structures, attributes like relevance, etc).

Resources can refer to any object potentially having value (information, technology, information-derivation protocols like science, social resources, physical resources, time, etc).

Priorities can narrow the focus of the problems or incentivize motion in a particular direction—like a priority to acquire resources, a priority to distribute information or rights, a priority to respect existing laws, etc)

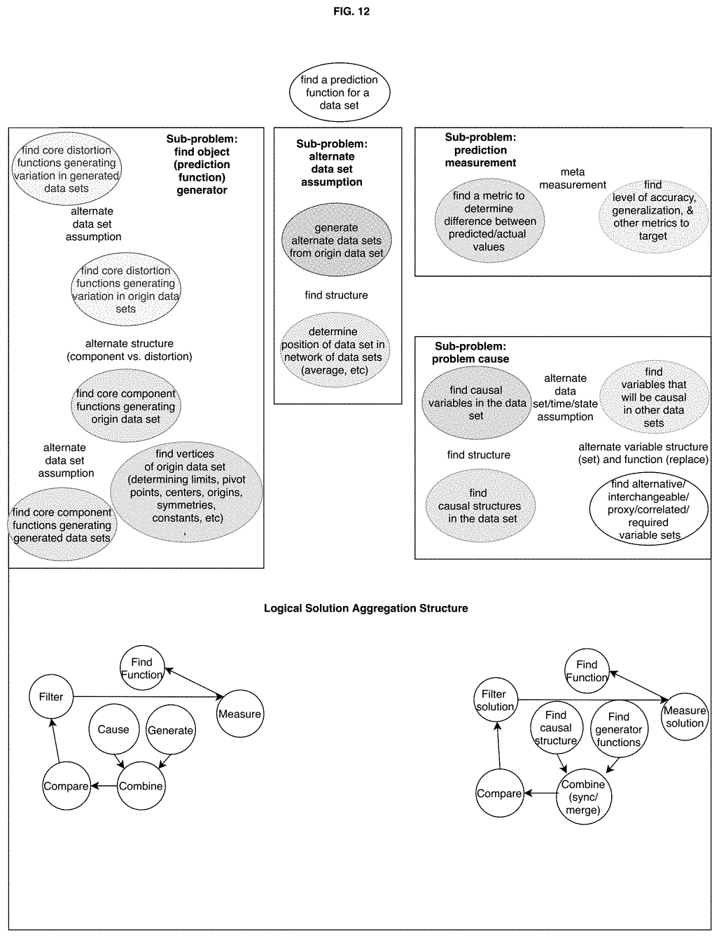

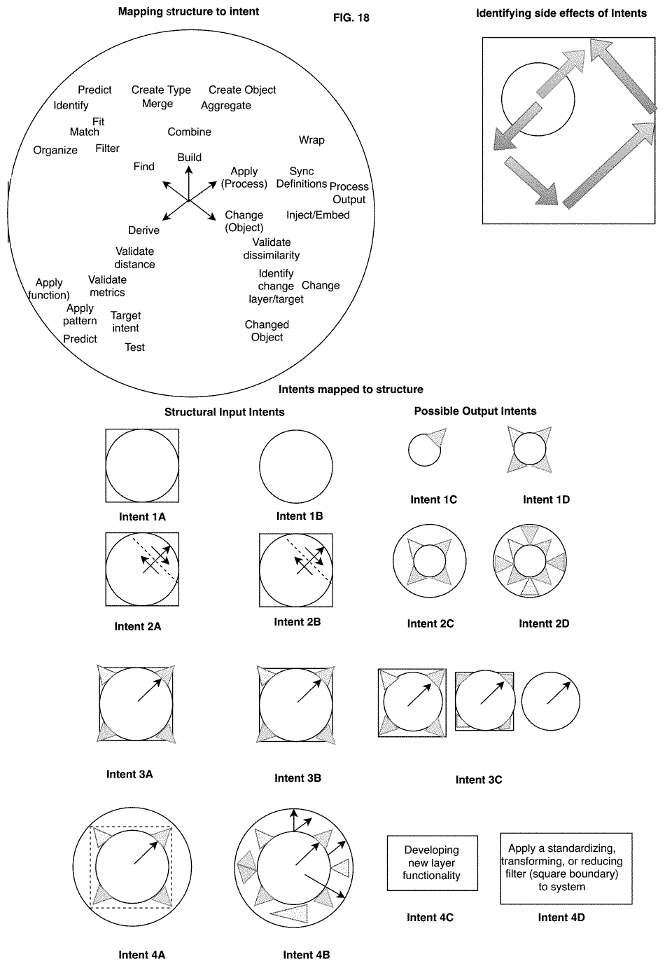

A standard applied to the problem space can mean a format, a particular definition of a concept like similarity, or a reducing function that isolates particular attributes, like how cause narrows the focus to dependency relationships, inputs & outputs.
function to match structures with coordinating formats, as shown in FIG. 9 with an example of matching problem formats with solution formats.
FIG. 9 depicts an example of formatting a problem (like finding a prediction function for a data set) in a different format.
   Problem format 1 depicts an example problem format such as: find core generators (triangle parameters of connective functions) of prediction function (dotted line) in system that can also generate other functions.
   Solution format 1 depicts an example solution format that coordinates with problem format 1, such as: core generative vectors.
   Problem format 2 depicts an example problem format such as: find system to generate prediction function.
   Solution format 2 depicts an example solution format that coordinates with problem format 2, such as: directed system network generating prediction function.
   Problem format 3 depicts an example problem format such as: find prediction function (dotted line) in system.
   Solution format 3 depicts an example solution format that coordinates with problem format 3, such as: base function network trajectory.
   Problem format 4 depicts an example problem format such as: find causal directions in variable network.
   Solution format 4 depicts an example solution format that coordinates with problem format 4, such as: directed causal variable network.
   Problem format 5 depicts an example problem format such as: find sub-functions or alternate routes for a function.
   Solution format 5 depicts an example solution format that coordinates with problem format 5, such as: vector sequence (to convert into another problem, reduce problem shape, fit a problem structure, fill problem shape,
generate the function, etc).
   Problem format 6 depicts an example problem format such as: find sub-intents linking a start & end node.
   Solution format 6 depicts an example solution format that coordinates with problem format 6, such as: intent network trajectory.
   Problem format 7 depicts an example problem format such as: format a function as a filter sequence.
   Solution format 7 depicts an example solution format that coordinates with problem format 7, such as: filter network trajectory.
   Problem format 8 depicts an example problem format such as: find problem types of a function.
   Solution format 8 depicts an example solution format that coordinates with problem format 8, such as: problem type network trajectory.
   Problem format 9 depicts an example problem format such as: find-patterns generating or generating an alternate to a function.
   Solution format 9 depicts an example solution format that coordinates with problem format 9, such as: pattern network trajectory.
   Problem format 10 depicts an example problem format such as: find distortion functions & bases generating a function.
   Solution format 10 depicts an example solution format that coordinates with problem format 10, such as: find distortion functions & bases generating a function.
function to apply an object to another object, as shown in FIG. 5 (Structure Application Function—Apply Function)
   example: applying a ‘route optimization’ solution may take the form of adjusting the system structure to invalidate the route, may attach a function to nodes, or inject an efficiency structure to the system, which may also reduce the problem dimensions in the problem space visualization in addition to changing the system structure in the associated visualized system-structure interface format of the problem.
FIG. 5 depicts the application of a solution to a problem space (standardized to the problem interface) in the top left, specifically the solution of adding an efficiency to the system, which reduces the problem dimensions (like resource limits), leading to smaller problem objects & decreased distance between problem objects.
It also depicts the application of a solution to the problem-containing system format (standardized to the system interface) in the top right, specifically the solution of adding an efficiency (like an alternate charging station in between nodes, or a position-switching function to each node) to the system, which removes the need for an optimized route between A & C.
Below these two examples, on the bottom half of FIG. 5, the figure depicts an example of applying the structural definition of an information function to information. This solution applies the structural definition of the Allocation function (in which information is distributed to other system positions), to the Input Info Distribution structure, to produce the Allocated Info Distribution structures.
The Allocated Info Distribution structures are structures of examples of two solutions: Solution 1 applies the ‘allocate’ function to both information resources, and Solution 2 applies the ‘allocate’ function to unique information resource.
each format is better for different information, problem types/formats (with varying structure in the problem definition) & solution intents, but if the user has a particular required solution format, they may need to translate a sub-optimal problem format into one associated with that solution format
each format involves a standard form like a set of vectors (which may represent a set of database/interface queries or insight paths, info objects like questions/insights/related problems, decisions/actions, causes/explanations, steps like removal/addition of variables, directed structures like distortions/intents, etc) which may be applicable in the interface network to retrieve/connect information, or in the problem space to reduce a problem shape, move around problem components to change the problem, or traverse a route in the problem network system (not necessarily the network of related problems, but the problem framed as requiring a solution route within a network)
example logic of function to find alternate solution formats in FIG. 11 (Finding alternate solution formats that fulfill different metrics)
   As shown in FIG. 11, different solution formats fulfill different attributes of the solution.
   For example, these solutions fulfill the route cost minimization aspect of the solution, but it doesn't enhance rewards of the route, if that's a solution metric determining whether a route is optimized, which can be determined with attribute-assessment functions like determining whether a structure matches a particular concept like ‘distribution’ or ‘equality’ or ‘organization’, which may be conceptual solution attributes. This type of function does structure-matching logic like that in FIG. 18.
   Solution format 1 depicts an example specific solution implementing an ‘application’ of the general solution of ‘cost reduction’ in an example solution format, like applying a ‘system structure change’ format (meaning structure).
   Solution format 2 depicts an example specific solution implementing an ‘addition’ of the general solution of ‘cost reduction’ in an example solution format, like adding a ‘system-wide cost reduction function’ format.
   Solution format 3 depicts an example specific solution implementing a ‘find’ of the general solution of ‘cost allocation’ in an example solution format, like finding an ‘optimal cost/benefit allocation, given a particular required path’ format.
   Solution format 4 depicts an example specific solution implementing an ‘application’ of the general solution of ‘cost reduction’ in an example solution format, like applying a ‘system function distribution (removing incentivized directions or changes)’ format.
   Solution format 5 depicts an example specific solution implementing an ‘application’ of the general solution of ‘cost reduction’ in an example solution format, like applying a ‘resource position change’ format.
   Solution format 6 depicts an example specific solution implementing an ‘application’ of the general solution of ‘cost reduction’ in an example solution format, like applying a ‘path shortening’ format.
   Solution format 7 depicts an example specific solution implementing an ‘application’ of the general solution of ‘cost reduction’ in an example solution format, like applying a ‘resource re-use’ format.
   other example logic to find alternate solution formats includes:
      how to identify alternative solutions that would be interchangeable with a solution in various contexts (like for different solution metrics):
      in other words, how to translate ‘find optimal route fulfilling a metric’ to an alternative interchangeable solution that makes the initial problem trivial to solve ‘find system-wide cost-reduction function that makes system routes equally costly’, at which point the original problem's solution is ‘any route’.
      we are looking for ways to invalidate the problem (generate an adjacent object to act as a proxy or replacement for the solution, generate the solution automatically, change the system structure so solving the problem isn't necessary, etc) rather than generate a specific solution (like how ‘trial & error navigation of all possible routes’ is a specific solution)
      inference sequence using definitions & problem definition:
         check definition: ‘route’ is defined as ‘a path between nodes in a network’
         standardize definition: ‘optimal’ can be removed because it means the same as ‘fulfilling a metric’ but adding ‘fulfilling a metric the most’ to translate it to the standardized form
         find definition (of metric)
         apply logic specific to metric definition, or general information-generating logic like a transform that doesn't change meaning in a context
         if the metric is the general ‘minimize cost’ metric of an optimization, apply a transform (‘abstract’ or ‘expand/apply/distribute’ or ‘change specificity attribute value to its extreme value’) that doesn't change the meaning, to produce:
         ‘minimize system costs’ (which doesn't prevent minimize the original cost so it doesn't change the meaning in an invalidating way)
      inject new version into original problem definition:
         ‘find route that minimizes system costs’
         check if definitions match logically: a ‘route’ wouldn't necessarily produce a system cost-minimizing effect
         if they don't match, apply transforms until they match:
         abstract ‘route’ to get ‘function’: ‘find system cost-minimizing function’
         check problem definition for extra information:
         the intent of the original problem was to minimize cost of a particular route, a problem that would be invalidated if all routes were equally costly; if we found a ‘system cost-minimizing function’ that minimized system costs, they might become equally costly, thereby invalidating the problem (invalidating it being one way of solving it), producing:
         ‘find a system cost-minimizing function that makes system costs equally likely’
      different structures fulfill different structural solution metrics
         if ‘cost’ is the metric, measured by total distance traveled, that is clearly different across the various solution formats of FIG. 11 (Finding alternate solution formats that fulfill different metrics).
functions to match & select a problem-solution connecting format trajectory
break the problem space into sub-problems, that can execute their own interface traversal & solution-matching process to find sub-solutions [symbol]
find a structure to combine solutions & combine sub-solutions to create the origin problem's solution, once the sub-solutions to sub-problems are found
example logic of function to break a problem into sub-problems, shown in FIG. 12 (Network of problem sub-problems, breaking a problem into component problems)
   this logic includes functions to decompose/aggregate problems/solutions (as shown in FIG. 12, Network of problem sub-problems, breaking a problem into component problems)

1. decompose a problem into sub-problems

2. solve sub-problems after the decomposition

3. identify structures to combine sub-solutions

4. apply structures to combine solutions & test combined solution output
The initial split of sub-problems is indicated in the boxes under the original problem statement, which is ‘find a prediction function for a data set’.
The subsequent splits of sub-problems are indicated with the connecting operations creating the splits in between the shapes inside the sub-problem boxes.
The bottom half of FIG. 12 indicates a logical solution aggregation structure, which depicts the logical method of aggregating sub-problem solutions into an origin problem solution, formatted as a directed network.
The sub-problem aggregating network on the left of the bottom half of FIG. 12 begins to resemble a sub-problem solution aggregating network on the right, with solution details such as requirements, queries, & operations applied.
This solution-aggregation structure can be applied to sub-solutions (like by positioning causative sub-solutions before filtering sub-solutions), given the logic establishing precedence (logic derivable with other interface objects, like using logic interface analysis indicating that requirements establish sequence of conditions, or causal interface analysis indicating that inputs establish direction of causation, since filters can be applied on info, so info is required to use the filter). Because causal structure & generator functions (core functions, variable/component combination functions, base-distortion functions, etc) are alternate solution formats of the origin problem, they can be merged & the output solution can be filtered for success solving the origin problem, ‘find prediction function for data set’.
These sub-solutions can be organized by dependence (causal interface) or requirement (logic interface). The causal structures & generator functions can link the data set to an output function format. The function format produced by the causal structures (such as linking variables in a causal network to generate the prediction function) & function generators (such as an average base with distortion functions generating the prediction function) is an input format to the compare function that compares alternative solutions (prediction functions). Applying structure to combine sub-solutions can also be done with analysis from other interfaces (insights like ‘connect formats by adjacent structures’ or patterns like ‘reduce complexity with standardization’ or intents like ‘find a sequence of solution formats matching this intent sequence’).

1. decompose a problem into sub-problems, using core functions like alternate/meta/find applied to problem objects (like how measurement is a core object of a solution, and the prediction function is the default solution object, and a variable is a sub-component object of the prediction function, and so on)
an example is breaking a problem into a problem of finding core components & arranging them in a way that passes filters formed by its solution requirements
   a requirement of a function that follows another is a possible match of input/output, if the functions are dependent, rather than relatively independent functions (occupying different function sequences), thereby translating a requirement to a filter that can be used to reduce the solution space to only function sequences that have matching inputs/outputs.

2. solve sub-problems after the decomposition

3. identify structures (like a sequence containing combination operations, or other combination structures like an unordered set, or filters) to combine solutions

After sub-problems have individual solutions, the user needs a way to integrate the sub-solutions so they can solve the original problem
for example, once the problem is broken into a set of filter structures to reduce the solution space, the user needs a way to arrange those filters so their output generates the solution (so that the input/output of the filters match, & the sequence of filters makes progress toward reducing the solution space).
the positions of each sub-problem set can be derived using logical positioning. A generative set should be followed by a measurement set because the output of the generative set (prediction function generated) matches the input of the measurement set (prediction function to measure); this involves a basic input-output chaining operation as mentioned before. A causal set may identify missing information in a variable set to establish cause between variables—that type of structure (missing information) should be followed either by generating the missing information, and if not generatable, should be integrated into the accuracy/confidence/error metrics, as not being able to find the information required to solve the problem (creating an accurate, robust prediction function).

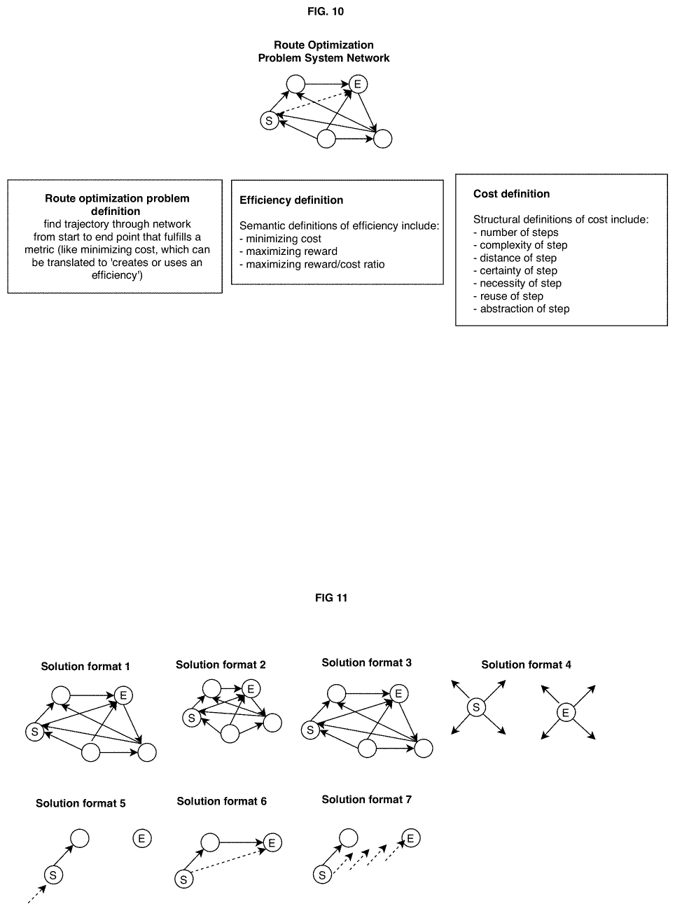

4. apply structures to combine solutions & test combined solution output
function to convert/represent objects (like a system/decisions/problem/solution) as a particular format (like a set of vector trajectories across interfaces, or a function)
function to check if a structure (like a solution) fits/matches another structure (like input assumptions & limits or a solution metric)
checking if a solution matches a metric structure is shown in FIG. 11 (Finding alternate solution formats that fulfill different metrics)
FIG. 10 depicts an example of object structure application, by applying a function to a structure containing an object to find specific object structures for that object).
   Specifically, FIG. 10 depicts an example of applying a solution function (like ‘apply definitions of objects’) to a structure (like a system or network) containing the problem (‘optimize a route’), to find specific solution structures for that problem (like specific functions or routes).
   As an example, FIG. 10 depicts a route optimization problem structure, to optimize a route from nodes S to E in a system network.
   The first step in applying one structure to find another is finding & standardizing definitions.
   The FIG. 10 includes a route optimization problem definition, an efficiency definition, and a cost definition, which can be retrieved from a data store or otherwise found/derived/generated.
   The default problem structure (for the route optimization problem) can have many solution formats, which apply the definition of efficiency (like resource re-use) and the solution metric (cost-reduction and benefit-maximization to reach the end point from the starting point) to network structures (like paths & nodes), given that the default problem format is in a network structure.
   Standardize definitions: focusing on the cost-minimizing definition, and the structural definitions of cost, we can standardize definitions to arrive at a structural definition of efficiency by applying the structural cost definitions:
      minimizing cost:
         minimizing number of steps
         minimizing complexity of step
         minimizing distance of step
         maximizing certainty of step (uncertainty is high-cost)
         selecting for necessity of step (only select required steps)
         maximizing reuse of step
         maximizing abstraction of step (unless abstraction adds steps like queries)
   Apply definitions to find matching structures: as an example of applying the object definitions to translate the problem into a solution, now that we have a structural definition of efficiency, we can translate the problem from ‘find a route between start & end points fulfilling a metric the most’ to a problem of ‘add efficiencies until cost is reduced’.
      Translating the new problem to add more structure (making it more specific & executable) means changing variables like:
         scope of cost (whether it reduces all costs or just a certain type of cost or just a cost on a particular route)
         type of cost
         type of metric calculation (how to calculate cost, cost definition, etc)
         type of efficiency (applying structural definitions of efficiency to the network structure, like route invalidation (position start & end in adjacent positions), cost distribution (routes are equally costly), cost reduction (path-shortening, system organization), cost invalidation (routes are equally costly), etc)
         logical & causal position of solution (create a cost-reduction generator or reduce costs for just this system)
         whether to re-calculate optimized route at each application of additional efficiencies
   function to compare & select between comparable solutions, optionally including selecting solutions based on input preferences selected (preferences like ‘avoid using ML in solution’, ‘use a particular interface’, ‘use pre-computed solutions from database’, etc)
   functions to select/add/remove problem dimensions
   functions to identify/reduce solution space
An example problem-solving automation workflow for a problem like ‘find an optimal implementation of an intersection’ (shown in application Ser. No. 16/887,411 FIGS. 1F-1I),

using the system/structure/concept interfaces.

1. Problem definition: determine possible match between the problem system intersection object and the system conflict object.

2. Standardize the problem to the system interface
Apply the context of the default interaction defined for the intersection (agents crossing the intersection)
Apply structures of possible matching objects in the system interface to the problem object, by applying the structure interface:
components capable of interacting (they have a nonzero interaction space) can be formatted as a network
the position overlap is an example of a tradeoff, so the ‘subset’ structure is applied)—this can be applied iteratively to check for structures that can be organized/optimized
the antagonistic agent & diverging direction components are merged with the agent component, where the diverging direction structure is applied directly and the antagonistic agent component is implied by their mutual approach of the intersection
the ambiguity system object is inferred by the match of the ambiguity ‘unenforced rule’ definition route, which matches the ‘agent traversal sequence’ intersection interaction attribute.
Now the intersection's default interaction (agents looking to cross) is formatted as a network, and system objects like conflict (and its sub-components, patterns, objects, etc) have been matched & applied to the intersection interaction network.
This is a structure of a problem type—‘find traversal sequence conflict resolution rule’—and given that it matches a known problem type ‘resolve resource competition’, it's likelier to be possible.
The traversal sequence rule can be found by applying other agent & intersection attributes, looking for system & other interface objects like:
irreversible changes (in case one agent will change the intersection in a way that prevents other people from traversing it, like burning a bridge)
intents that are higher priority
intent alignments (both agents have an incentive to apply social norms to maintain rule of law or trust, so their intents can be aligned to follow social rules to determine who traverses first, rather than building new rules to determine this).

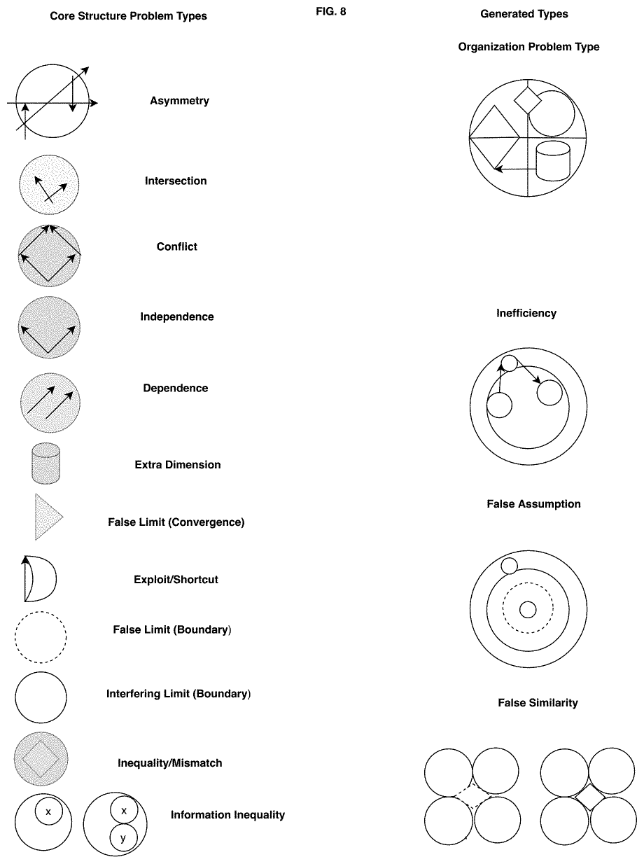

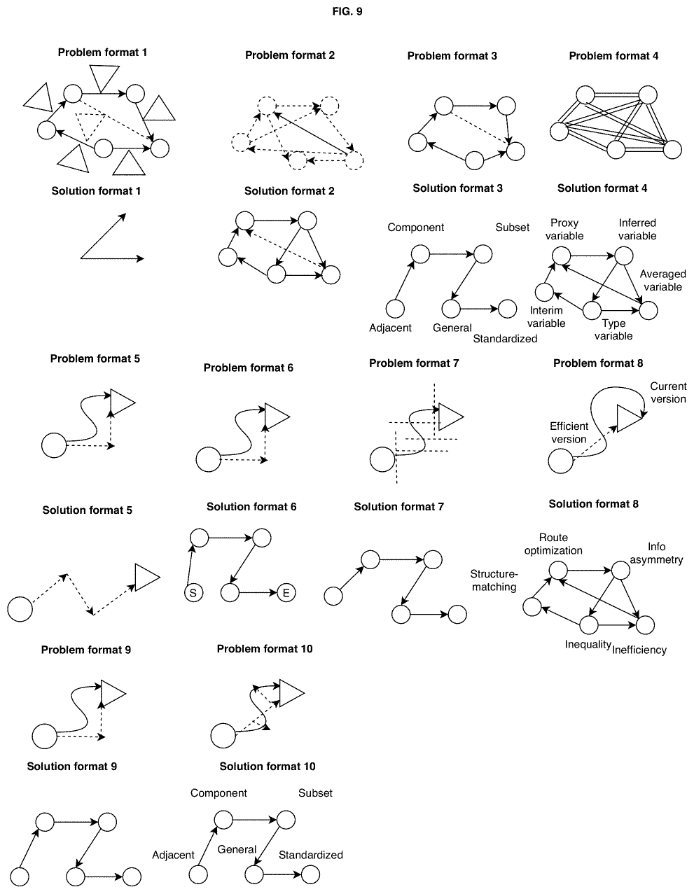

3. This step identifies whether the output of the previous step creates information that is easily transformed into the solution metric, given the relevant objects/attributes/functions of the solution metric. Is it clear which agent goes first, or whether the intersection can be changed in a way that determines which agent goes first?
If the solution metric 1 is fulfilled, the agents have no antagonistic agent attribute & there is no trade-off because no variance from a decision is allowed at the intersection.
If the solution metric 2 is fulfilled, the intersection loses its position overlap attribute & the diverging direction attribute doesn't matter anymore, but it does have a decision function at the intersection.
If the intersection object with the system interface is applied can be easily transformed into having one of the solution metrics fulfilled, that transformation can be considered a possible solution.
objects (problem, solution, problem/solution space/network)
structures:
   problem-solution formats (shown in FIG. 9 (Problem formats, with matching solution formats) & FIG. 10 (Problem-solution structure matching))
      a vector set is good for converting between problem-solution structures, like converting an inefficiency to an efficiency in a system
      problem shape-reducing vector set (where problem variables form the shape) is good for finding a function that reduces shape dimensions & size (like to form a summary), or a vector set to combine solution components in a way that fills the shape structure, if the solution format is a method to fill the problem structure rather than reducing the problem shape
      a route optimization problem has the solution format of a vector set between network functions/nodes (where nodes are states/problems/objects, etc) that is optimal in some way (hits a node/path, moves in a direction, minimizes cost of traversal, etc)
         with a network of states, the route can be a route between states with additional routes traversed within each state to convert to the next one (set of market states & trades to achieve a market intent)
      structure-matching can be a good format for finding an example, finding a reason, or finding a causal structure of variables for a prediction function
      an misalignment or mismatch (like an inefficiency, a conflict, or an information imbalance), where the solution format is the set of structures (which can be steps/vectors or applying a pattern or finding a structure in a network) necessary to correct the mismatch (minimize cost, align priorities, balance the information)
      abstract format of a query (break problem into information problem types and then the solution is a query of solutions for each of those solved problems)
concepts (anomaly, outlier, conflict, inefficiency, mismatch, inequality)
attributes:
   number of problem-causing variables/solution metrics fulfilled
   complexity: (number of core function steps required, variables, differences/inefficiencies, counterintuitive steps (requiring non-standard solutions), contrary processes (requiring scoped/nuanced solutions))
   abstraction (does it solve the same problem when framed on an abstraction layer above)
   number of steps required to create problem from stable system base state, once work is standardized, & adjacence of steps required
   how much work is required to convert to a particular problem format (route, combination, composition)
   structure of problem types causing or forming the problem (number/position of information asymmetries, resource limits)
   structure of information objects in the problem (decision points, variance sources, unanswerable questions of the problem, the structure of causes generating the problem if known)
   type/intent ranges/direction (of individual objects or composite stack)
   similarity (how similar to a standard problem type, or how near to limits within a type dimension)
   ratio of positive to negative outputs (problems solved vs. caused)
   inevitability vs. agency of problem cause
   agency involved in the problem
   problem types
      FIG. 8 contains examples of problem types & associated example structures.
      On the left of FIG. 8, structures for core problem types standardized to various formats are depicted.
      An example Info Asymmetry problem structure is depicted in FIG. 8, which is an imbalance in information (when depicted in an information format) or position (when depicted in a system format).
      An example Intersection problem structure is depicted in FIG. 8, which indicates a problematic intersection, like vectors that shouldn't interact.
      An example Conflict problem structure is depicted in FIG. 8, which indicates a conflict structure, such as the problem of selecting between alternatives, or the problem of conflicting vector like intents
      An example Independence problem structure is depicted in FIG. 8, which indicates an independence structure, such as orthogonal directions of change.
      An example Dependence problem structure is depicted in FIG. 8, which indicates an example dependence structure, such as where one attribute is determined by another which is used as a standard.
      An example Inequality problem structure is depicted in FIG. 8, which indicates an example inequality/mismatch structure between a solution (like a square shape) and a solution format (like a circle format).
      An example Information Inequality problem structure is depicted in FIG. 8, which indicates an example structure of an inequality of information, when formatted on the structural-information interface, rather than being formatted on a structural interface one layer of abstraction above it.
      An example Extra Dimension problem structure is depicted in FIG. 8, which indicates the structure of extra dimension added by integrating a circle across a vertical dimension.
      An example False Limit problem structure is depicted in FIG. 8, which indicates an example structure of a limit, such as a corner organizing change in a direction.
      On the right of FIG. 8, structures of problem types that may be generated with (operations like ‘combine’) are depicted.
      An example Organization problem structure is depicted in FIG. 8, which indicates an example organization structure, such as finding the right interaction layer to frame an interaction on, or resolving a mismatch/misalignment/imbalance is an organization problem space, where there are clear optimal structures for a certain interaction.
      An example Inefficiency problem structure is depicted in FIG. 8, which indicates an example inefficiency structure, such as navigating up an abstraction layer when there's no reason to do so.
      An example False Assumption problem structure is depicted in FIG. 8, which indicates an example false assumption structure, such as starting from the wrong starting point, or assuming there is a required starting point, or using over/under-restrictive limits.
      An example False Similarity problem structure is depicted in FIG. 8, which indicates an example false similarity structure, such as similar shapes that can develop with independent causes & contextual impact (for example, the appearance & behavior of a square between circles vs. an actual square).
      dependency/fragility
      mismatches
      conflicts
         intersection/collision
         comparison
         coordination
         competition
         conflicting direction/misalignment
         incentives/intents
         expectations/potential
         requirements/enforcement
         intent mismatch, like an unintended use (involves integrated third party tech not under review), like unintended side effects: whether it's a closed system or leaks variance (example: pre-computation, memory access, or process re-start event)
         misidentification
         incorrect structure (metric, information position, or organization/format)
      imbalances/inequalities (misdistribution of resources)
      inefficiencies (unmaximized benefit/cost ratio, such as unnecessary complexity/work)
      gaps
         missing information
         ambiguity (example: ambiguous alternatives)
         gap in rule enforcement
         gap in boundary (example: leaks (variance, resource/info), and injection points (assumptions/variance/control/randomness))
         limits, such as enforced rules, or limited resources/functions
   related objects:
      questions
         questions answered: this analysis definition answers questions like:
         what are the problems (inefficiencies, conflicts, mismatches) in this system
         what solutions are associated with this problem type
         what problems are related to this problem
         what problems will develop in this problem space system
         what is the probable cost of solving this problem
         what is the adjacent format of this problem

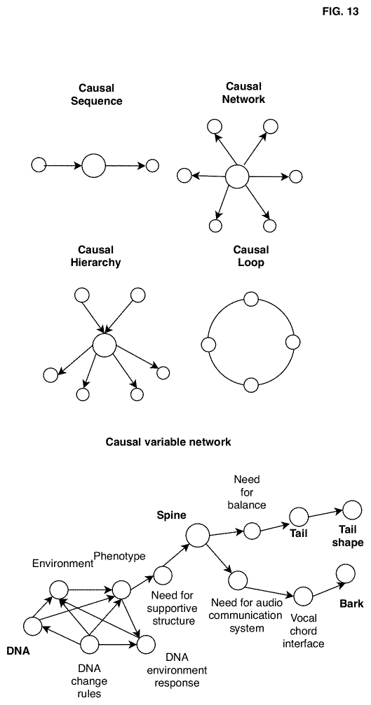

Method described in claims may include cause interface analysis mentioned as a component of interface analysis module 140 (optionally including example logic & output depicted in diagrams FIG. 13), with an example definition of the analysis as follows:
example interface definition for the causal interface:
   conversion function
      standardize to the cause object definition
      default conversion operations:
         mapping objects that can be converted
         adding/deriving missing objects required for the interface
         removing irrelevant objects
      conversion operations that apply other interfaces on top of the causal interface
         structure-function interface: linking inputs & outputs for causal functions that have structure (sequential functions, hub functions, etc)
         concept interface: identify dependency, state, adaptability, & agency
         structure-type interface combination:
         identifying causal types, such as ambiguous cause, structured as multiple alternate similar routes or multiple unenforced rules/variance injection points
   the conversion function can be formatted with many different formats (like filters/limits/routes/combinations) to achieve conversion intents (like add/derive/change/remove attributes, or apply metrics)
   the intent of the conversion function is to represent each component in the problem space (or data set) as a component of cause (attribute, structure, concept, related object, etc)
   the conversion function will attempt to standardize to related interfaces, if the minimum information for the current interface is not met
   adjacent causal interfaces (interfaces acting as inputs/outputs or with similarities to this interface, like how information, math, and structure are related interfaces)
   alternate/proxy causal interfaces (interface combinations/embeddings that can act in place of this interface)
   a structure with a causation attribute (standardizable to the causal interface) can have:
   causal attributes (causal inputs/outputs, function variables, causal metrics, and descriptive attributes like direction, ambiguity, relevance, uniqueness, directness, inevitability)
   causal types (root, direct, hub)
   causal functions (converge/diverge, catalyze, depend, isolate)
   causal structures (vector, tree, loop, network)
   related objects (related concepts like dependence, ambiguity, relevance, agency)
you can look for cause in structures by prioritizing:
   known causal structures & causal patterns
   causal vertex variables (like dependence)
   variables that are often found with cause
      combinations of identifying objects/attributes/functions, like ambiguous-direction or inevitable-unique structures
      causal function inputs/outputs
      related objects to cause
      preceding/determining/generative structures of these components (generative structures of related objects, causal function outputs, inevitable-unique structures)
cause object definition
   definition:
      cause can be defined as dependency
   objects:
      dependencies
   structures:
      most causal shapes are cyclical, layer, or network-shaped rather than one-directional vector-shaped (like a tree), which is why some existing methods are inherently incapable of producing system-fitted insights that wont break the system when applied (a particular drug that is not evaluated for bio-system impact, just impact on a particular pathogen or process)
      stack: set of adjacent (or other definition of relevant) causes
      causal loop: a function that generates information may end up using that information or its side effects like decisions as an input, creating a causal loop
   attributes
      identification/description variables
         degree (x is n degrees of cause away from y)
         direction: describes direction of control between nodes (x is always an output so it couldn't have caused y)
         interchangeability: can function as another cause (x is a proxy for z, so x & z are not both required to explain y)
         ambiguity: occurs with multiple alternates that are not clearly different in their input/output (alternative causes that cannot be resolved or invalidated)
         directness: adjacency of cause (x indirectly causes y, x immediately precedes y on a causal chain)
         uniqueness: describing whether multiple causes can be ruled out (x is guaranteed to cause y and nothing else does)
         inevitability: pre-determination of cause, which occurs from structure
         explicit/implicit (x is defined to cause y or x implies y)
         abstraction (x contextually or absolutely causes y)
         relevance
         set of possible alternate causes
         requirement/probability of cause (x must cause y regardless of most possible system contexts; if x this hadn't caused y, something else in the system probably would have caused y anyway, given all the similar structures in the system that interact with y, so x is not a required cause of y)
         generatability/controllability (how many inputs does the causal have, how fragile is the causation)
         dominance (x is almost always causative if allowed to interact with any object—example ‘a source of power’)
         function (x is descriptive rather than generative so it cannot be a cause unless descriptions are an input)
         difference from randomness
         difference between actual/possible functions (if an agent doesn't solve a problem, but they could have efficiently solved it, is the problem caused by them or its origin)
      types (apply attributes with varying values to generate core types)
         root cause: an origin cause of a causal branch
         catalyst: triggers cascade of causes
         hub: a causal node where causes aggregate, are generated, or connect (like a structural or information cause)
         indirect/inevitable/ambiguous/unique cause
         relevant cause: cause on similar interaction layer or in similar position as:
         agents (‘describe the problem’ has relevant causes like direct cause)
         agent intents (‘intent to invalidate the problem’ has different relevant causes, like the root cause)
         alternate cause
         interface causes
         structural cause
         cause from position
         cause from interaction layer
         concept cause
         balance/power as a cause (balance/power attributes/functions caused the output)
         causation bases
         decision-based cause (from an agent)
         time-based cause (the cause is the default/natural progression from a prior state)
         random cause (from lack of agents or organization)
         inputs (interaction, adjacence, similarity, cooperativeness, potential, structure, change)
         outputs (inevitability, influence)
         description attributes (structure, type, causation potential, randomness)
         generative attributes (structure, system context, change rules, object identities, interaction iterations)
         metric attributes
         number of steps between causal nodes (measures directness of cause)
         number of possible causes (measures uniqueness/ambiguity of cause)
         function parameters
      function interface
         patterns
      functions
         core functions
         inherits structural core functions (combine, merge, rotate, convert, format, limit, enforce)
         resolve: identify cause in a set of possible alternate causes
         isolate: identify contribution of a particular cause to an output
         inject/extract dependency
         identify causal structure, as shown in FIG. 13 (Causal structure-matching)
         FIG. 13 shows causal structure-matching on information standardized to the cause interface.
         In FIG. 13, the program logic may fit variables to a causal structure, like one of the structures depicted in the top half of FIG. 13.
         A unit example of a causal loop structure is where the output of one function is re-routed to its input.
         An example of an alternate cause structure is where multiple conditionally interchangeable but independent causes can activate a function.
         An example of a causal chain/sequence is a simple sequential set of causes linking the objects/functions, with no alternatives & having one direction.
         This analysis answers questions like ‘how would you identify which causal structure applies to a set of variables?’
         As an example, to determine the causal structure for a dog's tail shape, bark sound, spine, and DNA, logic may:
         identify that DNA causes the other features, and identify other causes involved
         identify the actual causal structure, which is the causal variable network on the bottom of FIG. 13.
         to generate that causal variable network, the logic may identify interfaces like environment & change rules,
         it may also identify the concepts in the bio system relevant to those interfaces (mutations, regulatory mechanisms, DNA copies, etc)
         then the logic may apply the causal structure between the environment & DNA to generate interim causes like needs or stressors, which create demand for change in DNA.
         You can also identify those causes using other interfaces:
         system objects (identifying incentives in the bio system rewarding adaptive responses to stressors or maintaining DNA, matches between environment stressors and changes to DNA, sub-interfaces that provide a platform for change to develop like the spine provides a platform for variation within change limit)
         structure objects (identifying the rules that act as hub nodes, like change rules do, identify sequences like needing an audio communication system on the vocal chord sub-interface, once that interface is enabled with a spine, so the spine acts as an input requirement for the bark).
         answers the question:
         why did something work (because of its causal position/structure/layer/pattern/interactions/attributes/similarities)
         what layer of the causal stack is the relevant cause
         change functions
         change structure
         change intent
         change cause metrics
         change cause attributes or attribute values
         change causal direction
         dis/ambiguate (clarify) cause
         distance/connect cause
         apply/inject cause
         intend cause (use a cause to fulfill an intent)
         require/invalidate cause
         assume cause
         depend/isolate
         converge/diverge
         boundary functions
         cause is not:
         lack of a resource that couldnt be expected (divine intervention, meaning/reasons/incentives, connection across distant systems)
         condition/context functions
         cause of the same event can have different structure across contexts, such as:
         being poisoned by a plant while lost on a hike (evolution, randomness, lack of information, low agency injection) has a different cause than taking the substance for a research experiment (high level of agency injection), and this will impact the causal structures activated by that substance (being eaten by bears, receiving antidote)
         conditional cause functions assess the conditions/context of a cause, to determine contextual (system-fitted) cause
         accidentally taking luggage on a plane that someone planted drugs in often has a different cause than agreeing to do it
         unless the only reason they accidentally didnt check their luggage was fear of gangs, and if the agreement would also occur be of fear of gangs
         functions include:
         determine causal position relative to other causes (like context or system structure)
         determine range of possible structures of a cause, with other conditions/contexts applied
         apply context/condition to a cause
         connecting functions
         combination functions
         these functions determine how causes of different attributes/types/change states interact, answering questions like: how does an agent cause combine with a structural cause?
   related objects of causal interface
      information interface
         definitions
         cause: input, power, excess unhandled energy, lack of organization
         strategies
         ‘when creating ambiguity, use abstract rules’
         insights
         ‘causation is a relative term’
         questions
         ‘which causal relationships should be checked first when finding variable relationships?’
         context
         system context
         problem space context
         dimension set context
         spaces where cause is measurable (dimensions maximizing or displaying differences)
      intent interface
         causal intents
         outputs (direct/combined/emerging)
         side effects (indirect side effects of outputs, processing side effects like locking inputs, opportunity cost of processing)
         intent vs. incentives: an intent without an agency cause is an incentive
         incentives are usually considered less causal than intents, from the agent perspective:
         agents cant be expected to go against incentives every time, as theyre generated by system structure
         but agents can usually inject agency into the system, to change its structure & the intents resulting from it
         intents exist outside of the system, which can motivate agents to change a system
         so structure of a system is not the cause of all causes, but it is an important interface to apply on top of the causal interface
         if there is an absolute root cause, it may be change rules (how systems change)
      concept interface
         core causal concepts
         state: important for identifying sequential causation
         structure: important for identifying inevitable causation
         agency: injection of intent into structure (like with organization)
         adaptation: important for identifying causal potential (an organism that can learn/change is likelier to be causal)
         dependence (structure: causal links)
         mutual dependence (structure: causal loop)
         ambiguity vs. determination/uniqueness (reducing possible alternatives)
         determining concepts
         adjacent concepts
      type interface
         attribute sets differentiating objects
         attribute sets without types
         type hierarchy
      system interface
         causal system
         system objects
         symmetries/efficiencies/similarities
         definitions (difference, power, direction)
         system functions
         core system function (apply, inject, combine) definitions on the causal interface
      structural interface
         structures
         structure network (links between causal & other structures)
         causal structures
         causal structure network (links between causal structures like sequence, hierarchy, tree, network, etc)
         structures (filters, limits, maps, networks, trades, sequences, links, circuits)
         determining structures
         input/determining structures
         filters
         functions
         structures identifying cause
         tree origin (root cause)
         adjacence (causal degree)
         layer (alternative cause on layer)
      interface operation (combined/applied/injected) output
         intent-structure interface
         intents identifying cause
         aligned intents (compounding cause)
         pattern-structure interface
         ‘a causal tree often has multiple layers & may converge to fewer nodes’
         structure-function interface
         functions as structures (filters, limits, maps, networks, trades, sequences, links, circuits)
         structure functions (traverse, combine, find, build)
         cause-concept-system interface
         causal concept system
         system objects
         symmetries/efficiencies/similarities
         definitions
         structures (networks, trades, sequences, links, circuits)
         system functions
         core system function (apply, inject, combine) definitions on the causal-concept interface

Method described in claims may include change interface analysis mentioned as a component of interface analysis module 140, with an example definition of the analysis as follows:
example of the analysis for this interface:
   change analysis relates to information interfaces (question, problem), logical interfaces (function, intent, pattern) and potential interfaces (variance, risk, certainty)
   change analysis analyzes relationships between objects/attributes/functions
   change analysis is important for identifying:
      how relationship structures (distortions, origins, combinations, sequences) relate
      when change is imminent to assess the value of identifying future states (gather more data for a prediction function, implement versioning, build interfaces for change into the function by parameterizing/abstracting it)
      what is the best way to frame a change (on what base, with what variables that describe the change, in what spaces/systems, as a combination of what functions, as a change of what uniqueness)
   related to the information (certainty) and potential (uncertainty, risk, predictions, possibility, probability) indexes
   variance is semantically the opposite index (gap) to the filter index (limit)
   variance/difference type analysis:
      part of the problem with using a one-directional vector to model a relationship is that the underlying parameter (usually time) may not be relevant for predicting the relationship evolution
         rather than modeling it by a standard of changes over time, it can be modeled by a standard of changes over variance potentials
         will a particular variance source change compoundingly or converge to a constant in all possible parameterizations of that variance source
         does a particular variance source have the potential to generate variance or will it eventually become static in all possible implementations, meaning it either:
         doesn't exist (at any time), like a final output that doesnt ever return to interact with other systems as an input
         is one of the few things that does exist (across all times), like a concept that never stops influencing variance
      this is the problem of adding/fitting/reducing structure from a gap in structure, which can be used to solve problems like:
         prediction: which variables are explanatory, given what we can measure
         causation: how alternatives can converge to the same level of variance or change patterns
      reducing gaps in rule enforcement to shapes or paths has its own set of rules
      this interface can also be used for specific attribute analysis, of properties that descend from concepts & take form in a specific problem space:
         the power concept interface (has implementations that look like trust, info, etc)
         the balance concept interface (has implementations that look like symmetry, justice, etc)
      what is the path definitely not, based on various maximized measures of similarity?
      what attributes & attribute sets & attribute dependency trees differ
      what is transformation cost/potential between objects
      what is divergence distance between generative paths for each object
         example: “what is the probable function linking these variables, given that it is an adjacent transform of a square (related function type), & a distant transform of a manifold (unrelated function type)?”
      variance accretion
      what variance is unexplained
      at what point does a variable become relevant to another variable interaction layer?
      how do constants accrete between rules, like caps to keep variance from flowing in to corners or creating boundary-invalidating openings in a system/component boundary?
      what causes variables to cascade across layers, creating fractal variables?
      delegation of variance into systems/types/functions/variables/constants
      what type of variable is it? (object-differentiating/identifying attribute, emergent specific/abstract property, direct function input/output)
      how does the variable relate to other variables? (decisive metric, substitutable alternative, collinear)
      given that variance flows through systems in patterns, what are the common variance shapes, given host system type & structure+set of unknowns?
      as change increases:
         how do interface objects (functionality/intent/potential) or change objects (structures/functions/variables/embedded parameters/spaces) change
         which standards/interfaces/change types are adjacent (change framed based on deviation from a standard, like deviating from the correct order or probability distribution, measured by degree of stacked distortions)
         which difference definition applies (changes framed based on difference type, optionally including difference from value, symmetry, limit, origin, number type, pattern)
         what probabilities/possibilities become possible/adjacent (adjacent meaning findable/generatable in structural dimensions/on the structural interface)
      as a concept having structure (like power: degree of independence) changes, does the change definition erode (previously distant points become more equal to adjacent points, so the meaning of information about position/dependency erodes, as power to move between them increases)
      where can change be stored/routed in a system: if there is demand for change (stressors demanding new functionality) but all components but one are maximizing their change handlers, then you know theres one potential variable where change will gather/be routed, if its possible to route change from the variance injection point to that variable's causal stack at some layer/point
attributes:
   uniqueness (is the change composable with core distortion functions or is it formed with different functions than other changes, implying its origin is external to the system)
   inevitability (is the change pre-determined by the system, in which case its just a continuation of a state progression rather than a fundamental change or source of variance)
   directness (adjacent change)
   explicit/implicit (certain/uncertain change)
   degree (how much was changed, to what level of distortion)
   change types (create, cause, force, guarantee, convert, enable, depend, connect, structure)
   different ways to create the change (if there are many ways to create it, each individual way is insignificant)
objects (equality (alternate, interchangeable), difference (extreme, opposite, contradictory), change source)
concepts (base, similarity)
structures:
   variance structures (gap, leak, cascades/catalysts, accretions/injections, compounding variance, variance building a new interface, variance distribution/alignment, unenforced rules, measurement limits, open systems)
   change structures (variables, dependencies, updates, replacements, distortions)
      base: varying change bases (what a change's differentiating output is defined in terms of/in relation to) allows various difference types to be measured (removing common parameters/attributes or standardizing by a base), such as change defined as:
      similarities (‘if you remove attribute x, are they equal?’)
   certainty structures (patterns, rules, constants, assumptions, limits, metrics, information, similarities/matches/alignments (intents/incentives, demand/supply, limit/variation) [symbol] , definitions)
functions:
   function to derive change/change type/change base
   function to differentiate
   function to convert: change a component into another (useful for identifying alternate paths)
   function to deconstruct: change an object into its components (useful for identifying origins & common components)
   function to distort: apply a distortion function to acquire a difference object (a value difference, an extreme, a magnification, a limit, etc)
   function to map change types to dimensions
   function to identify dimensions where change types change (an aggregate, interface, or deciding dimension where change type is uncertain but not random), with embedded parameters & bases for framing changes of a certain type
   function to identify the variance structures (gaps/cascades/filters) in a system, to identify the best dimension sets to frame certain change types in
change types:
   change from different bases (randomness, core, default, etc)
   change in change structures (change stack, circuit, sequence) or functions (derive change, derive change base, convert, differentiate)
   state change (requiring a new position on a state network)
   variable change (requiring more/less/new variables or fundamentally altered versions of existing variables)
   interface change (what interfaces are adjacent/determining/generative/differentiating across the change)
   interface object change (what concepts/intents differ, does potential increase, are other change types enabled across the change)
   change based on system vertices (imminent to/distant from a phase shift, at an intersection, changing interaction layers)
   changing attributes (like systematization/stabilization) based on a concept (like randomness)
   changing object change based on a changing interface (change stack, like changing orientation of an object within a system that is changing)
   changing change types (variance leak, variance cascades/activation, variance injection, compounding variance, variance approaching an interface, variance distribution)
   as change increases, what change objects (types/rules/rates/direction) alter position/connection/distance/existence?
   does a change increase or reduce: attributes/functions of change like a change definition/change sources/core change functions/change rate/change type/change interface
   what changes develop into change structures like randomness/constants/change cascades
   change can be framed on other bases like potential, because potential is a related object to change (if there is no potential, there is no change)
   certain change types have certain intents associated
      potential-based change is aligned with intents like prediction (finding patterns like convergence or cascades)
   some changes are complex (changing many different things) that cannot be clearly depicted as an increase or decrease, but are still noteworthy as they are adjacent to an increase or decrease (increase the probability of an increase or decrease) even if they dont register on that dimension set
      in this case, a set or network of related spaces can be used to represent the change
      other spaces can also change what value means in that space, to represent more complex attributes like concepts (potential), where a change alters several metadata attributes of that base concept (potential direction/reversibility/alternative count/probability of alternatives leading to more potential)
      for example, a change may not directly/measurably increase the potential of a system, but it could be similar to changes that preceded an increase in potential of a system, so it should be represented on a pattern dimension set (representing the similarity to the other pattern) or a similarity/change dimension set (depicting the similarity to that other preceding pattern's intra-differences within itself), even if it can only be represented as a point rather than a change on the potential dimension set
   patterns are related to potential be if something is too compliant with patterns, its less likely to change, which is an object of potential
   with regard to graphing potential itself, it's more useful to use position as a base rather than time
      how does potential change with respect to starting position?
      if a starting position is isolated, there is less potential for dependence & more potential for independence (the net impact on overall potential is variable)
      this reveals more information about actual potential change types by placing useful limits on value ranges
examples:
   when approximating area of an object that is similar to a square but has a convex arc instead of a side (like an opened envelope), it may be more efficient to:
      calculate the integral of the arc-ed shape and add it to the square area
      alternatively, if those functions arent available or if the arc is a very low angle and similar enough to a straight line:
         the arc can be broken into sub-lines & the area of those shapes calculated & then added to the square area
      rather than deriving an integration method for the non-linear side, it may be more efficient to arrange questions to solve the problem based on change:
         question sequence based on change:
         ‘what is the non-linear object definition’ (arc)
         ‘how does area change with angle of arc’ (in proportion to degree of distortion from line)
         ‘what distortion functions generate the arc from the distortion degree’
         ‘what distortion is present in the observed object’
         this is a specific case of answering the general question:
         ‘how does this parameter (area) change with respect to distortion from default object (line)’—a question that can be broken into the questions:
         ‘what degree of distortion is the different object (arc) at’ (how many distorting n iterations build the arc from the line, which is similar to calculating the log base line of the arc, given the available distortion operation to connect them)
         ‘what is the impact of each distortion on the parameter (area)’ (what is the impact of each distorting n iteration on area)
      it's also like calculating: (number of distortions between line & arc) A (impact of each distortion on area)=difference in area between line & arc,
         which is using a pattern of change (impact of distortions on area) instead of calculating a way to approximate the area parameter with integration (aggregating subsets that are easier to calculate)

Method described in claims may include potential interface analysis mentioned as a component of interface analysis module 140, with an example definition of the analysis as follows:
example of the analysis for this interface:
   variance is semantically the opposite index (gap/unenforcement/missing information/randomness) to the filter index (limit/structure/information/organization)
      delegation of variance into systems/types/functions/variables/constants/objects
   analyzing potential focuses on what errors/functionality/structure is possible/allowed/prevented
functions:
   identify high-risk variables
   identify imminent variable changes
   function to frame change on potential interface:
      as change increases, how does potential (possible change) increase:
         what probabilities/possibilities become possible (findable/generatable in structural dimensions/on the structural interface)
         what possibilities become adjacent/distant
         does a change increase or reduce potential options?
      as potential changes, how do potential objects/types vary based on the unit of potential (possibility distance, distance between required limits & optional steps)
   function to organize position by adjacency determined by probability (more probable changes are more adjacent)
      there may be symmetries and limits preventing certain changes from being possible, given a starting point, so each point on the change interface has a set of possible starting points, and traversing the change interface often means a set of points rather than a continuous function, so the set of points needs to be converted to a space where they can be a continuous function to describe time-based change
      function to apply/measure change according to time-adjacent variables (potential, change) to increasingly remove the meaning of time structures (like dependence/order/state/prior position), as certain change types make more or all positions possible
      function to remove conditions restricting potential (like order, irreversibility, possibility, measurability), eventually leading to the symmetric state where functions producing change would be equivalent to/generative of each other (the theoretical liquid can generate the theoretical cup in that space if it needs to, injecting more time/potential in a prior position on its timeline to further current goals (based on change potential—the set of possible moves given by its current position), which require less change/time/potential than anticipated)
      function to maintain potential (alter structure like position/dimension/interface)
         dont execute a decision change until needed: allow potential to maintain its superposition (not resolved to a certain structure/path/point) so when you need to, you can choose an aligning path from that potential that fits the post-selection trajectory
      function to add potential as needed:
         remove traces of resolution into a choice by undoing the root cause up the causal stack (like removing an attribute can restore an object to an undifferentiated type)
         add variance-handlers to restore potential lost be of change cascades that take up time (buy more time by handling current & anticipating imminent change)
         remove limits (movement, information, boundaries, rules, structure, attributes) to enable new combinations
         acquire power (time, position, information, & other input resources) which is a proxy for potential (range of alternative options)
         remove filter determining loss of potential/change by mapping that filter to another one
         create efficiencies (shortcuts) to allow existing objects to interact in new ways
         change definition of distance so all combinations are possible and adjacent to remove time cost to travel to them
         change faster than other changes so other changes could never catch up without your change methods, which youve left information out of so they'd all need to be used together to build your change rate from a different trajectory
      function to identify potential structures (conversion potential/interaction space)
      function to identify/analyze variables as potential/uncertainty or information/certainty sources
         what type of variable is it? (object-differentiating/identifying attribute, emergent specific/abstract property, direct function input/output)
         how does the variable relate to other variables? (decisive metric, substitutable alternative, collinear)
         at what point does a variable become relevant to another variable interaction layer?
         how do constants accrete between rules, like caps to keep variance from flowing in to corners or creating boundary-invalidating openings in a system/component boundary?
         what causes variables to cascade across layers, creating fractal variables?
         what is a structure definitely not, based on various maximized measures of similarity?
         what attributes & attribute sets & attribute dependency trees differ
         what is transformation cost/potential (divergence distance) between objects (like generative functions)
         what is the probable function, function range, or mixed probability/certainty function (with probable & certain subsets) linking these variables
attributes:
   structure (potential being lack of information, and information being structure)
concepts (randomness, risk/probability, opportunity, certainty, variance, enforcement, validation)
objects:
   interaction space
   potential field
uncertainty/potential structures:
   unused resources (paths/energy/combinations)
   adjacent states accessible with existing/available resources
   complex systems (which have greater complexity than that which can be understood by its observers using existing tools) like markets
   risk generators (variance-producing variables, such as equal distribution of information, randomizing functions, etc)
   boundary/limit-changing functions
   risk structures: a chain of risks (uncertainties) is a common structure seen in market patterns (such as trades, product engineering, demand assessment, & prediction markets)
   risk-reduction structures (using diverse models to check predictions rather than one)
      categorizing functions (delegating risk to the accuracy of the function combination of variables, constants & operations)
      boundaries/limits (minimizing risk & establishing probabilities)
   risk-distribution structures (distributing different information to different positions/agents)
      probability distributions (delegating risk to accuracy of distribution selection)
   probabilities (probable convergence/divergence points like filters, constants, etc)
interaction layer (layer on which objects are likely to interact)
interaction space (set of possible interactions)
potential field (range of potential states or positions)

Method described in claims may include structure interface analysis mentioned as a component of interface analysis module 140, with an example definition of the analysis as follows:
example of the analysis for this interface:
   indexing objects by structure allows clear matching of useful structures to objects/attributes/types/rules
   this allows objects to be graphed in a standard way, which means translating objects like problems into a computable interface
structures (dimension, position, sequence, set, scale, range, spectrum, line, center, vector, circuit, network, tree, stack, distance, origin, point, angle, direction, boundary, edge, limit, inflection point, intersection, tangent, ratio, symmetry, scalar, path, expansion, progression, distribution, layer, space)
attributes (order, balance, equivalence, accuracy/fit, position)
objects (comparison, combination, permutation, approximation, metric, activator, trade/cost/benefit, change, filter)
concepts (equivalent, alternate, substitute, opposite, inverse)
functions:
   identify components with structural attributes like chainability (cause, risk, variance, errors, gaps, limits) or variability
   identify a shape fitting information: chain/stack/network/mix/layer, adjacent shapes, or emergent info shapes like alignments/gaps/conflicts
   will a type stack (which type values on different type layers) or a network/tree (type hierarchy) be a more useful structure to capture a type relationship
   identify compression/conversion functions of a shape
   identify structures in objects: which objects are chained (cause, risk, variance, errors, gaps, limits), which are dimensions (isolatable attributes of change patterns), which have position
   find important structures (combinations/layers/matches/differences/sub-components)
   map structures (function sets) to target structures (sequences), given a metric like progression toward goal
      identify sub-components
      a function to convert an object between formats (function=>attribute sequence, function=>filter sequence, etc) by mapping attributes & functions & other metadata of the objects & removing attributes that don't fit in the target format definition (for example, if you're converting to a type, the output should be in an attribute set format)
      a function to identify structure matching a pattern (like identify a structure embodying a mismatch, which is a problem type, given a system network definition, where the system could represent an object, function, or attribute)
   structure identification functions
      identify shape: chain/stack/network/mix/layer
      identify adjacent shapes
      identify compression functions of shape given target dimensions
      identify transformation functions of shape given source/target shape
      identify alignments/symmetries/gaps/conflicts
      choosing between structures (like nodes & links) to model another structure (objects in a network):
      node: many connections to many other objects having a similar property, like having a type in common, usually unique
      links: usually many connections between two objects at a time, having many possible variations, can be repeated
   example of structural analysis by applying a particular structure:
      market analysis: the market interface is a standard interface where resources (goods, labor, time, risk, information, expectations, theories, & stored prior labor (currency)) are traded
         a useful new way to use this is to frame non-resource objects as resources (systems, structures, positions, paths, directions, risk chains, trade loops, markets)
         then you can apply traditional market analysis (optimal transport) to find, for example, the optimal set of trades to change an industry's position
      time analysis: as time increases, what changes:
         position
         value (position on a dimension)
         distance (position from a base point)
         changing position based on embedded time
      as change increases, what structures change (which structures are stable even in certain change rates)
   apply other standard structural bases as alternatives to time, where change is on a y-axis, and these parameters are on the x-axis
      order: changes are framed based on order—to examine change patterns with respect to order (where unit order is original/standard and highest order is most different order possible)
      position: changes are framed based on difference from previous position, starting from the standard unit position (default)—for examining change patterns with respect to position distortion
      distance: changes are framed based on distance type (distance from value, distance from number type, distance from pattern)—for examining change patterns with respect to distance type
      value: changes are framed based on value type (exponential, constant, pattern value, symmetric value, origin value)—for examining change patterns with respect to value
      set: changes are framed based on set membership (number type (prime), pattern (progression), distance (adjacent groups))—for examining change patterns with respect to sets
      space: changes are framed based on spaces where that change can be framed (topologies, dimensions, vector spaces)—where spaces are formed by adding dimension units
   mapping a structure to an item (value, variable, object, type, system etc) requires an algorithm that:
      matches variance with structure change potential
   organization/format analysis
      optimal path/distribution/states
      what would the optimal path be, given a certain intent, object identity, & host system?
      “what is the function linking these variables that is most efficient/involves fewest variables/involves known constants?”
      identify layer to solve a problem at
      identify key objects needed to solve a problem
      identify structures for information

Method described in claims may include logic interface analysis mentioned as a component of interface analysis module 140, with an example definition of the analysis as follows:
example of the analysis for this interface:
   automating the selection, position, optimization, & implementation of logical rules is possible with this analysis
   this analysis can optionally include related interfaces of logic (patterns, functions, intent, cause, change)
   this analysis is used at its most basic level for identifying valid rules (‘x, so y’ or ‘x, so not z’)
   relevant logical objects with defined rules optionally include assumptions, requirements, implications, conclusions, fallacies, inferences, etc, and logical structures like sequences, connections, alternatives which follow the rules of logic (some rules have to follow other rules, logically, so their appropriate structure is a sequence—whereas some rules cannot be implemented simultaneously like mutually exclusive rules, so their appropriate structure is a tree branch)
   using these logical object definitions & associated logical structures, you can derive what is logical in any given rule set
   this means you can derive emergent structures of possible error contexts/rules, like:
      when there is a difference between the implication of a rule and the implementation of handlers for that rule, there is an opportunity for misuse of that rule
      if you have logic to handle the ‘dog chases cat’ rule but you don't have logic to connect & handle the causes of that optionally including ‘the cat did something’, then the ‘dog chases cat’ scenario could cause variance in the system, such as being used out of context (even when the cat did not do something), or not being prevented in the system (by handling what the cat did to prevent the chase event)
      when an assumption may seem to fit in a system where its applied (assume that people are biased), but the implications of that assumption don't fit the system (the system user/designer/implementer may also be biased), the assumption shouldn't be used or should be adjusted to fit the system (all agents are potentially biased at any point because bias is part of the learning process)
      enables automation of the selection, structurization (limiting, connecting, scoping, positioning), optimization (reducing number of rules or high-cost rules or distributing/reducing costs better), & implementation of logical rules
functions:
   function to identify logical problem types
      gaps in logic enforcement (variance gaps, fallacies, incorrect contexts, assumptions)
      overlapping/repeated logic checks (extraneous validation)
      side effects that don't match function logic objects, like implication
   logic correction functions
      identify isolated logic operations
      identify scope required of each operation
      identify required position of each isolated logic operation
   logical operations:
      building a conclusion out of logical units means each assembly step complies with the rules of the space
         “adding a line to a line may produce a square, or an right angle, but it wont produce a circle”
attributes (validity, cohesion (measure of system fit, like fit to a ‘common sense’ or ‘pattern’ system))
objects (fallacy, assumption, implication, justification, explanation, argument, conclusion, contradiction, inference/deduction/guess)
structures:
   logical overlap, conflict, limit, gap, misalignment
   logical sequence (logic that has a position attribute, where it has to follow or be followed by other logic)
   logic tree (logic with contradictory alternatives that cannot occur simultaneously, to handle different conditions)
   logical connection (logic that enables other logic, because their inputs, outputs, & objects like implications match rather than contradict each other)
   logical circle (a logic structure that depends on its output)
concepts:
   necessity (does a route necessarily imply a conclusion)
answers questions like:
   is this rule logical or does it have logical errors like contradictions
   do these rules contradict each other
   does this rule fit the system it's used in
   is this assumption valid
   are these rules fit to the right logical structure
   does this rule prohibit another rule
   should this rule follow this other rule
   what is the implication of this rule

Method described in claims may include pattern interface analysis mentioned as a component of interface analysis module 140, with an example definition of the analysis as follows:
example of the analysis for this interface:
   a pattern can be or contain any structure, optionally including a function (the pattern being a sequence of logical steps) but it is different from a function in that it is more abstract & can optionally include other structures, and the point of the pattern is not to get a particular object like the function output, but to identify common trends across systems so the pattern can be used for inference or value generation
   a pattern is a relationship between objects, the point of storing which is to identify repeated relationships
   the relationship between objects is not the only part of the pattern that matters—the actual object identities may be an integral part of the pattern
   for instance the pattern ‘1 1 2 3 5’ may have a relationship like ‘a subset of the fibonacci sequence’ but it also may be important that the sequence starts at 1 (the initial object identity) because it may be used for calculation
   so the trajectory mapped by a pattern may not be all that matters—the starting/ending points or values of the pattern may also be relevant
   this is different from a function which would have abstract starting/ending points in addition to the sequence of logical steps, to govern where the function can be used
   patterns that are common across systems imply a level of increased probability of that pattern occurring in other systems, so patterns can be used to infer attributes like probability
functions:
   generator: generates a pattern given parameters
   compress (reduce the pattern to a generator function)
   expand (generate a sequence using a generator function)
   implement (apply a generator or sequence to a structure in a context)
attributes:
   abstraction: a pattern can be a pattern of specific values (1, 2, 3, 4), the metadata of those values (type: int int int int, divisor attribute: odd even odd even, exclusive divisor attribute: prime prime prime not-prime), or an abstract version of the values (number, pair/number of points required for a line, sides of a triangle, number of players required for a game), or a mix of these
   structure: a pattern can optionally include any structured information, optionally including a set of logical steps, a set of attribute values, a list of events, a query on a graph, a trajectory in a tree, a list of numbers representing feature values, etc
   relevance: is the pattern relevant for another structural context
   composability: what patterns can a particular pattern be combined with
   completeness: whether the pattern is complete
objects (components (any type of structured information is allowed in patterns, with values like integers, words, other patterns, references to objects, etc))
structures (sequence (sequential pattern), network (a pattern of relationships))
concepts (repetition, relevance)
answers questions like:
   what would the path between inputs/output probably be, given patterns of other paths
   what is the function linking these variables, given common function patterns between variables of these types/topics/ranges/other metadata?

Method described in claims may include intent interface analysis mentioned as a component of interface analysis module 140 (optionally including example logic & output depicted in diagrams FIG. 18), with an example definition of the analysis as follows:
example of the analysis for this interface:
   intent can be defined as possible reasons to use a function (or use an object as a function):
      possible outputs (optionally including the explicit intended output, resource access/usage like memory retrieval, object lock, routing information to a function while it's being looked for elsewhere, or processing usage, and side effects)
      explicit intents (‘calculate x’)
      implied intents (the implication of an intent like ‘calculate x’ is to ‘use the output of that calculation to make another decision’)
      embedded intents (implementing a function optimally has an embedded intent of ‘optimize this function’)
      injectable intents (intents that can be injected into a range of functions, like the ‘use processing power’ intent can be injected into any function)
attributes (implication, directness, alignment)
functions:
   allow combination of intents to find malicious intent structures (like a sequence of neutral-intent functions that has an emergent malicious intent when used in that sequence)
   operate on intents (intent-modification intent)
   derive intent as a dependency of the intent interface conversion function [symbol]
   map intent to direction & assess solution progress by movement in that direction
   mapping intent to structure & vice versa is shown in FIG. 18 (Intent-matching)
      FIG. 18 depicts examples of matching operations between intent & structure.
      In the ‘Mapping Structure to Intent’ section on the top left of FIG. 18, mapping intent to direction is depicted in a system as allowing the identification of different intents, given the general intent of the direction.
      In the ‘Identifying side effects of Intents’ section on the top right of FIG. 18, an example of deriving intents in a system—intents that have side effects—is depicted.
         The system limits may force someone prioritizing a priority to move in certain directions that they ordinarily would not if left to make their own decisions in a vacuum.
         They start from a selfish priority, moving in the direction of being uncriticizable and building functions to enable that intent, and by the system they're operating in, they're forced to move in other directions (making a gesture of charity, copying agent with priority of improving functionality of other nodes), while still having the same intent.
         The agent prioritizing that priority will have pivot/angle/rotation functions/concepts, and their decisions will be buildable with those functions. The agent prioritizing improving other nodes' functionality will have cooperation, sharing, problem-solving functions and their decisions will be buildable with those functions.
         This is an example of how different intents can not only have the same output (arriving at the same end node), but a similar/overlapping trajectory at various points, while still leaving traces of different intents in their side effects (traces such as functionality developed to serve different intents, at different stages of development).
      In the ‘Intents mapped to structure’ section on the bottom half of FIG. 18, examples of structural input intents are depicted on the left, which can adjacently support example structural output intents on the right.
      For example:
         Intent 1A (Unenforced equal growth) and intent 1B (Enforced equal growth) may support intents like intent 1C (See which entity gets to the corner first) and intent 1D (Create the emergent entities).
         Intent 2A (Inject variance in growth inputs) and intent 2B (Inject variance in growth inputs) may support intents like intent 2C (Create field of potential for emergent entities to grow, either within an existing or new boundary) and intent 2D (Create interaction space on emergent entity layer).
         Intent 3A (Inject variance in state (position after a process)) and intent 3B (Incentive to move toward corners decreases, leading eventually to corner erosion) may support intents like intent 3C (Create temporary interaction layer as needed to resolve question of which entities emerge or create their functions, then dissolve it by switching their positions).
         Intent 4A (Create evenly distributed growth incentives once corner objects & functions develop) and intent 4B (Remove square boundary & let all functions & objects develop new interaction patterns in outer circle) may support intents like intent 4C (Developing new layer functionality) and 4D (Apply a standardizing, transforming, or reducing filter (square boundary) to a system).
structures:
   intent matrix is the interaction space of a set of intents, where its emergent intents can be traced across the interaction space
   intent stack is the set of adjacent intents of a function, from granular/neutral/abstract to specific/explicit, across various interfaces like logic, abstraction, & structure
answers questions like:
   which intents should follow or be combined with which intents
   which intents are likelier, given the context implications of the function
   which intents are missing, given an overall function intent
   which intents do the optimized/simplest/reusable function versions fulfill
   intent-logic interface question: which intents align with logical objects (assumptions, conclusions)
   intent-system interface question: which intents are common to all functions in the system
   intent-function interface questions:
      which functions are most exploitable for malicious/neutral intents
      which functions' explicit intents don't match their implicit intents (or emergent intents when combined with other functions), which is like analyzing the structural difference between developer expectation vs. user intention
   do variable, type, logical, & output intents match overall given function intent
   what is the logical sequence that best fulfills this intent (useful for automating code generation)
      what is the function linking these variables, given the variable intents a, b, c and the combination intent matrix ab, bc, ca, and the possible output intents of that matrix, and similarity to output intent of y
   what intents/directions/priorities does this path align with or could be built from?
objects (priorities: abstract directions that intents may fulfill or move agents toward, whereas intents are more granular)
concepts (applicability: what a function can be used for)

Method described in claims may include function interface analysis mentioned as a component of interface analysis module 140, with an example definition of the analysis as follows:
example of the analysis for this interface:
   the function interface can include patterns, logic, strategies, rules, and any other set of operations/objects that has order
   a function can be any of the following general types:
      rule: a static function
      function: rule tree, composed of:
         conditions (if/for/while/validation/organization)
         assignments/relationships (equate an attribute with a value)
         processes (an altering process like format, a routing process like return, etc)
      intent: purpose for a function (at granular layers or in strict environments, purpose can be tightly aligned with the function logic, with no side effects)
      role: function & a position in a system
      pattern: sequence or other relationship structure of specific/identified objects (like a sequence of rules, filters, or values)
      connection: causal relationship (some type of interaction occurs)
      insight: important/relevant/new/unique/abstract/cross-system relationship
      strategy: insight & a plan intent on how to implement it, usually to achieve a specific goal intent
      this interface extends the core function definition of the object format, which refers to any logical rule, and applies a comprehensive definition that can standardize & describe the function potential of other objects
attributes (state, complexity, context, environment, optimization/automation/alternative potential, function type (core/boundary/abstract/change/potential)
   alignment: enforced/optional, core, required, emergent/output (built from core functions, with or without associated intent)
   interaction: cooperative/conflicting
   intent: generative, filtering, grouping, organization/delegation/distribution/matching/grouping/filtering, classification, differentiation/transformation
   scope: use case, context, range, host system
   related objects (like host spaces/systems & object positions in those)
functions:
   interface-specific functions (find logical fallacy, organize, solve a problem, derive an intent, find dependencies, inject variance, maximize potential, conceptualize)
   automation functions
   math functions
   interaction functions
objects (errors, assumptions, side effects, input/output parameters, parameter types, definitions of concepts like equivalence specific to a function)
structures
   formats (core functions, filters, sequences, limits, network/tree representation, probabilities, attributes)
concepts (contextual fit: a function is not completely defined without usage contexts)
answers questions like:
   are there multiple directions to approach function derivation from?
      can patterns in metadata-generators (difference generators) be used to derive the function generators (core functions)?
      does it loop around to the start, just like lowest math/structural interface (symmetry, equivalence) loops around to highest conceptual interface (balance, power, random)?
      the shape of the interface nexus should be a circuit feeding itself
      (fractal inputs to itself, where input interfaces are similar in that they can both generate & be generated by the current interface)
      this means you can select an optimal interface to start from & a direction to navigate in on the standard order of interface traversal, and an optional interface-organizing metric (like difference) to order interfaces to traverse
how to evaluate change with respect to function/intent or other function metadata:
   as change increases, does functionality/intent change and in what direction?

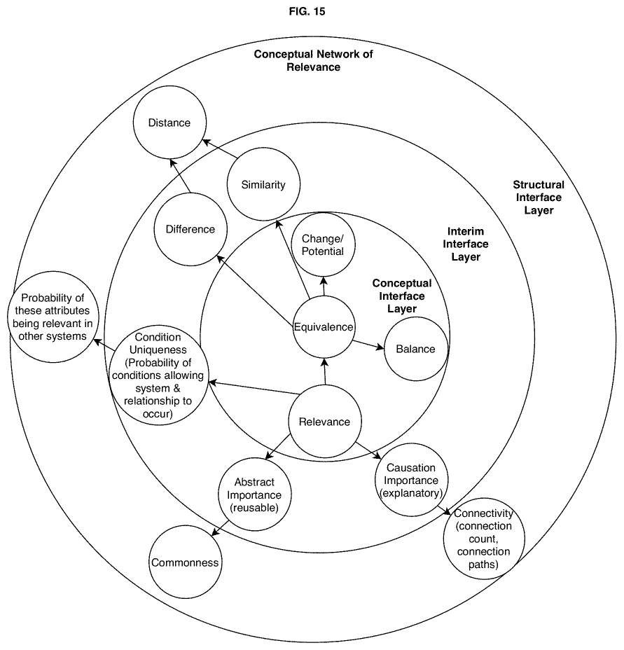

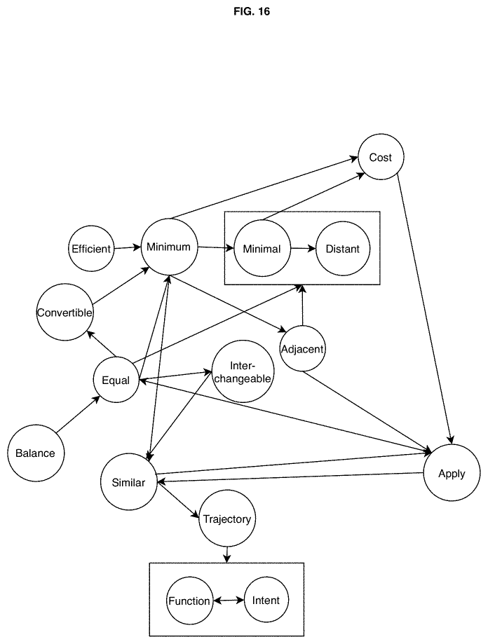

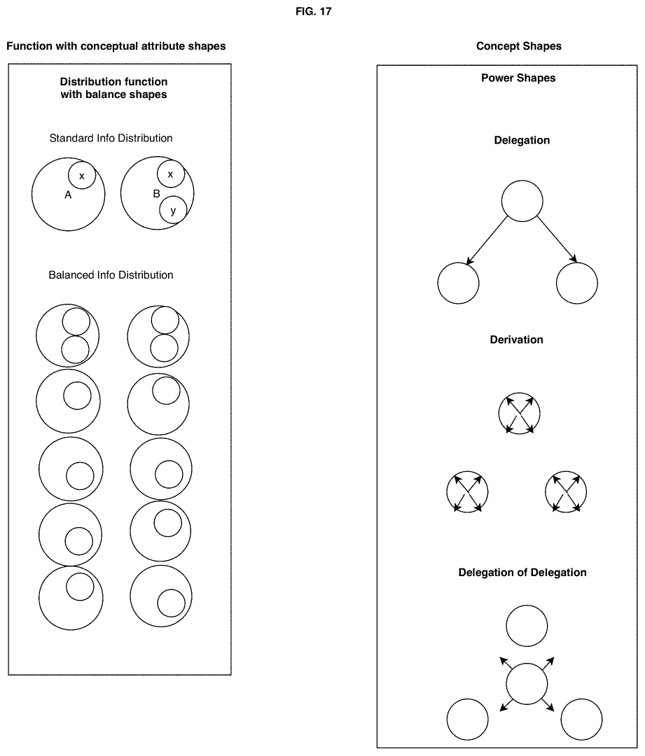

Method described in claims may include concept interface analysis mentioned as a component of interface analysis module 140 (optionally including example logic & output depicted in diagrams FIGS. 15-17), with an example definition of the analysis as follows:
example of the analysis for this interface:
   a concept is an object in a system that:
      extends the core components of the system in a new way (introducing a new object on the system layer graph of core component combinations)
      acts as an interface (for change, randomness, etc) or determinant of change
      has attributes/functionality beyond its definition in that space (can have one function in one system context & another emerging function in a particular state & environment)
      example: power is the object left when objects implementing it: resources=>energy=>input=>potential) have their context removed, navigating up the abstraction stack from the info layer (resources & energy), removing their contextual attributes/rules, to the abstract structural layer (input) [symbol] , to the abstract layer (potential, which is a related concept of power) [symbol] , so that the final object is defined in terms of other abstract objects on the top layer
      the abstract network is a set of related concept objects remaining after removing context, concepts that are applicable across systems, often have multiple definition routes because they take a variety of forms given the context, and are fundamental to describing a system. A subset of the abstract network is depicted in FIG. 15. Concept definition network, which shows concepts related to ‘relevance’.
      so that the final object is defined in terms of other abstract objects on the top layer
   a non-abstract concept is an abstract concept with structure applied (in a particular system), like how a particular definition of similarity in a system can evolve from the abstract concept of equivalence
   example structures that apply a concept are depicted in FIG. 17 (Match structure for a definition of a concept), which depicts structures of the ‘distribution’ and ‘power’ concepts.
      In the example ‘distribution’ function on the left of FIG. 17, a distribution function (that implements conceptual attributes like balance) is depicted, which may produce the Balanced Info Distribution example output from the Standard Info Distribution input.
      In the example concept structures, such as the ‘power’ concept structures, on the right of FIG. 17:
         a ‘delegation’ power structure is depicted, which indicates that information is sent to other entities for processing work.
         a ‘derivation’ power structure is depicted, which indicates that no information is shared except derivation tools.
         a ‘delegation of derivation’ power structure is depicted, which indicates that all entities delegate to entity with no caching/data retention power, only processing power.
   this interface can be used for specific attribute analysis, of properties that descend from concepts & take form in a specific problem space:
      the power concept interface (has structures that look like trust, info, etc)
      the balance concept interface (has structures that look like symmetry, justice, etc)
objects (abstract network of structural, irreducible cross-system concepts, like power, balance, etc)
structures (abstraction layer (level of specificity/certainty in a structure), systems where the concept fits as an interaction object, trajectory to generate the concept in conceptual networks)
concepts: definability (how clear is the definition, given the level of structure like context applied, making a concept concrete rather than abstract)
attributes (abstraction, uniqueness, isolatability)
functions:
   function to identify/derive/define concepts in a system (unique objects in a system that cant be defined in terms of standard operations on other objects)
      example of possible definition routes for the concept of ‘equality’ are given in FIG. 16. Alternate definition routes
         FIG. 16 depicts an example of alternate structural definition routes for ‘equality’.
         For a concept like ‘equality’, the structural definition routes (standardized language map trajectories) may include:
         interchangeable (similar enough to be usable for the same trajectories (functions/intents))
         minimally distant (adjacent enough to be usable for the same trajectories)
         efficiently convertable (convertible with sufficiently minimal work as to be usable for the same trajectories)
         For another example, the definition routes for the ‘power’ concept may include:
         structural definitions: alternatives, connection hub, input
         concept-structure definitions: potential, change potential, change activation, truth source, truth access point/path (power being formattable as information)
         concept definitions: freedom, independence
         info definitions: energy
         The alternate definition routes for the ‘truth’ concept may include:
         ratio of information you need to ignore to make something seem true (low number of required conditions being an indicator of truth)
         ratio of successful usages (repeated usability, or robustness)
         ratio of fitting contexts (fit with other truths)
      example: ‘meaning’ concept definition (relevance/structure) is based on attributes like reduction of signals (relevance) and matching of signal structures (similarity)
   function to identify abstract concepts, by attributes like whether they:
      can take many structures (the concept of equivalence has many possible implementations)
      can impact many systems varying by system attributes or system types (abstract, calculatable, variable, understood, types, functional, prioritized, optimized)
      cannot be perfectly defined as a simple function of other objects, but rather are definable with a set of simple, core boundary rules that differentiate them from other concepts
         these boundary rules do not involve other concepts on the same layer, but rather core components
         for example, the core components of common shapes are: line, point, curve, corner
         the set of common shapes are the uniquely identifiable combinations of these components (circle, square, triangle) that are not identifiable as simple transforms of other common shapes, but rather are composed of simple limit rules based on their core components (line, point, curve, corner)
         “enablement” doesnt perfectly capture “power”, and the concept of “enablement” also relies on the concept of “power”, but it does differentiate power from other concepts & unite its possible implementations & meanings
         “symmetry” doesnt perfectly capture “balance”
         “similarity” or “substitutability” or “identity” doesnt perfectly capture “equivalence”
      are uniquely identifiable compared to other concepts
         balance is related to symmetry so these are not unique concepts but embedded/dependent/overlapping/hierarchical concepts
         however balance is clearly differentiable from power, as balance inherently involves equivalence and power doesnt, whereas power inherently involves enablement and balance doesnt
   function to identify structures generating a concept or concepts generating a structure:
      example of finding a structure generating a concept:
         create a program that checks if a system is robust automatically, regardless of which system: what would a concept like ‘robust’ mean for a system?
         given the definition route to ‘robust’ as ‘strong enough to withstand various circumstances’, you can infer that if a system is robust, it can retain its structure despite application of various change types
         so query for change types in that system, then check which change types break the system & the ratio of (change types handled/total change types)
         assign a ratio to ‘strong’ adjective, then check if the change type handled ratio is above or below the strong ratio: if above, the system is ‘robust’
         independence can be created with closed trade loops: the most basic example is where agent A produces everything agent B needs, and vice versa
   conceptual math functions:
      an example is applying the concept of ‘meta’ to the concept of ‘game’ and getting output of the operation like ‘a game where games can be created by agents inside the game’ or ‘a game to design games’, given similarities between attributes/functions of objects in the definition & relevant spaces
      apply one concept to another (apply ‘power’ to ‘market’ or ‘evaluate market by power’ involves standardizing the market concept in terms of power, using power as an interface)
      apply concept to a structure, as a priority
   function to evaluate conceptual change
      example of concept-based (power-based) change:
         as power (degree of dependency) changes, what else changes:
         previously distant points become equal to adjacent points as power increases
         value reverts a concept & the information of the value loses its meaning
         dimension space can be determined by the degree of dependency
         does a change increase or reduce power?
         this can be framed based on potential (bc power can change with respect to options), variance (because power can change with respect to change), and time (bc power can change over time)
   answers questions like:
      what concepts cannot be reduced/abstracted further
      what concepts have which associated structures
      what definition routes identify a particular concept
      as change increases, how does a concept (like similarity) change
      what concepts are likely to evolve in a system
      what concepts are common to most systems (would help identify concepts like an efficiency)

Method described in claims may include system interface analysis mentioned as a component of interface analysis module 140, with an example definition of the analysis as follows:
example of the analysis for this interface:
   this is a format accessible once information is standardized to object model
   this involves framing information as a connected network with a boundary defining the system, that has core system operations, structures, & objects
structures:
   structural system objects like connections/boundaries
   structures applying info system objects like variance/dependencies/equivalencies/efficiencies/incentives/asymmetries (info/risk/time)
objects:
   information objects
   variance objects like variance injection points (gaps in rule enforcement) & variance sources (problem types, gaps in system boundary allowing variance from other systems to leak in)
   tradeoffs: options with mutually exclusive contradictory benefits (if you take one option, you have to sacrifice the other), often a false trade-off or dichotomy applied when both are simultaneous options rather than contradictory
   incentives: a reason to take an action (a benefit or cost)—usually interpreted as default in a system
   inefficiency: defined as not using a cost-reduction or benefit-increasing method (using extra unnecessary resources, not using a requirement-reduction method, not reusing solutions, etc)
   opportunity: potential move with a potential benefit, with a limited time component
   exploit opportunities: opportunity with temporary local (selfish) benefits that allocates cost disproportionately to the system (destroying a system-maintenance concept like ‘trust’ or ‘rule of law’) or other objects in the system, with negative emergent side effects (hoarding resource incentives, requirement for monitoring & rule enforcement investment, misallocation of justice)
   vertices (factors that generate or influence the system development)
functions (optimize, traverse, open/close, apply system filters, reduce dependencies, close variance injection points, enforce rule, identify system objects given their definition, such as a variance gap, map a system layer graph representing combinations, identify/derive system context, find interactions of interaction spaces (which interactions are common across agents, likely given other interactions, etc))
   function to generate a different object (like a different concept network) by varying attributes:
      example: if power favored centralization, another core concept like balance would have to favor a chaotic process or not exist at all, or another core concept would need to be added to the network
   function to predict which system filters will be useful based on a system priority
attributes (cohesiveness)
concepts: closed system (a system that can exist without other systems), optimized system (a system that generates zero variance, whose inputs/outputs are all connected without side effects)
answers questions like:
   where are the inefficiencies in this system
   how can this system be optimized
   are too many assumptions hard-coded in this system
   is this system capable of a particular function
   does this system coordinate with other systems in a stable way
   is this system adjacently exploitable
   does this system contain more potential (options) than it needs
   what input/output paths are available that can achieve a particular intent
   where would this system generate coincidentally similar structures (a query to identify false similarities)
   what system structures (or buildable system structures) fit in this unknown information-generating sub-system
   system-problem interface: what problem types does this system have
   how does a system become overwhelmed with variance (in various forms, optionally including randomness), does it have outlets like interfaces with other systems to delegate variance

Method described in claims may include object interface analysis mentioned as a component of interface analysis module 140, with an example definition of the analysis as follows:
example of the analysis for this interface:
   this is a standard information format commonly used in programming, optionally including object/attribute/function information
   the unique implementation of this used in this tool optionally includes attribute type information, function metadata, and object derivation logic, as well as operations to merge objects & other common operations on these components
   attribute definition:
      attributes of an object contain information about other structures/functions of the object
      ‘is an object strong’ translates to the question ‘does the object have functions that enable it to execute tasks at high performance’
      the ‘strong’ attribute refers to a net effect of the set of structures (its functions) that fulfills a metric (like high performance) relating to a state that the host object can occupy consistently, making it an identifying quality (attribute), while not required to remain in that state (can be a variable attribute, with multiple potential values)
      if a system works well or is efficient, it may fulfill the attribute ‘strong’, which means that any structures of efficiency/high-functioning (like aligned benefits/costs or aligned intents/incentives or reused functions) may be assignable to the concept of ‘strong’, given that those can be components/inputs of strength
      attribute types like input/output, descriptive/identifying/differentiating, abstract, causal, constant/variable/parameter, dependency/requirement, type attributes, etc
      structurally, attribute can be represented as information flows like inputs/outputs, as emergent characteristics like additional ways to change (adding color or sound to a structure or additional embedded structures like a field/scaffold/layer)
   object definition:
      objects can be represented as a set of structures (like limits isolating change or vectors of change) that identify unique or isolatable objects, which act as a cohesive set of components (attributes/functions/sub-objects), or represented by context, given its position on a structure like a network, depicting its relative position to other objects
      objects have boundaries differentiating them from other objects, containing their functions/attributes/sub-objects if present
   function definition (metadata like input/output parameters)
   definitions are identified by definition routes, which are alternate paths in a standardized language map (with language formatted to use interface terms) to define a object/attribute/function
      the more abstract a concept, the more definition routes it may have
      definition routes may reveal a particular structure of a concept, like how power is associated with delegation structures and can be optionally defined as ‘ability to delegate’
attributes:
   measurability (is an attribute measurable, is its value range knowable)
   default format (is a component more similar to an attribute or function)
objects (type, state, definition)
structures (attribute sets, type hierarchies, state networks)
concepts: standardization (defining objects in terms of core/structural terms), core components (sets of components that can be used to construct other objects in a system)
functions:
   identify data sources (code bases defining schema/class definitions, network maps) automatically with a search to identify tabular data in web resources
   import (to import objects/attributes/functions)
   object functions: define, create, derive, identify, change, version
      definition (definition route) functions
      definition operation functions (merge definitions)
   structural functions: combine, merge, apply, embed, mix, filter, chain
      example: combining a function and an attribute can mean:
         changing any structures/metadata of the function that are capable of fulfilling/displaying/hosting the attribute
         applying the function to the attribute to change its definition
         which operation is used depends on which type of combine operation is used (merge, embed, intersect, union, version, merge with a particular conflict resolution definition, etc)
answers questions like:
   what attributes do these objects have in common
   what are the differentiating attributes of this object set
   what is the relative position of this object on a network of objects
   what attributes emerge from this object set
   which objects change in what ways
   what is the net functionality of the object set
   how do/will these objects interact

Method described in claims may include core interface analysis mentioned as a component of interface analysis module 140, with an example definition of the analysis as follows:
example of the analysis for this interface:
   this describes the common components that can build other analysis types
objects (interface objects like patterns & concepts)
structures (core structures (intersections, hubs, vertices, maps, limits, symmetries, & alignments))
concepts (abstract concepts (similarity, power))
attributes:
   interface attributes (intent/priority, potential/certainty, perspective, causality, abstraction, interface queries that can produce this object)
   commonness, scope, optimization, completeness, randomness, reusability, complexity, dependence
   contexts (coordinating/opposing, use cases, extreme cases, examples)
   coordinatability: integration potential
   interaction layer: which objects it interacts with, on what layers of a system like abstraction/scope layer
   injectability: can it be used as an input, in many operations
   emergence: is it generatable from other objects
   neutrality: the range of operations/contexts it can be used for
   automation/optimization potential (resource investment, rule stabilization) [symbol]
   applicable definitions (like for equivalence)
   minimum object identification information (required identity attributes)
   relationships
      adjacent/related objects of same/different type [symbol]
      problems with adjacent objects & how those problems are generated by adjacent object metadata [symbol]
functions (structural functions: combine, merge, apply, embed, mix, filter, chain, define, create, derive, identify, change, version)

Method described in claims optionally includes the aforementioned interface analysis types mentioned as a component of interface analysis module 140, as well as other optional interface analysis types, which optionally includes example analysis type definitions that allow for automation of that analysis & allow for the application of specific functions powering that analysis (custom analysis functions like ‘find the set of questions or formats that makes finding a solution trivial’), examples of these custom analysis functions being provided in the example interface analysis definitions above.

As indicated above, FIGS. 1-22 are provided merely as examples. Other examples are possible and may differ from what was described with regard to FIGS. 1-22.

As shown in FIG. 23, a user may be associated with a client device, a server device, and a interface analysis module 140. In some cases, the user may wish to utilize the client device to access information (in formats such as a text document or data set) provided by the server device. As further shown in FIG. 23, and by reference number 105, the server device may provide document information to the client device. In some implementations, the information may include information associated with the document, such as textual information provided in the document, information indicating locations of the document at the server device (e.g., uniform resource locators (URLs)), information indicating folders storing information associated with the document in the server device, information indicating files associated with the document that are stored in the server device, and/or the like. As further shown in FIG. 23, the client device may receive the document information, and may provide a user interface (e.g., a web browser) that displays the information to the user. As further shown, the user interface may include a mechanism (e.g., a button, a link, a browser plugin, and/or the like) which, when selected, may cause the client device to generate a request to traverse interfaces to use as information formats to fulfill the input intent, using the document information. As further shown in FIG. 23, and by reference number 110, if the user selects the mechanism, the client device may provide, to the interface analysis module 140, the document information and the request to traverse interfaces to use as information formats to fulfill the input intent. The interface analysis module 140 may receive the document information and the request to traverse interfaces to use as information formats to fulfill the input intent. In some cases, the user may alternatively wish to utilize the client device to access information provided by an API or website, which could be downloaded to the client device & uploaded in the user interaction module 110 or retrieved by API specification. Alternatively, a program running on a server device configured by a user may send a request to traverse interfaces to use as information formats to fulfill the input intent to the interface analysis module 140, which includes an API to access interface analysis module functions, and returns the output information 150 to the requesting program on the server device running the program.

As shown in FIG. 23, and by reference number 145, the interface analysis module 140 may include a interface analysis module repository, containing:
an index of info objects (data store containing info objects like queries, definitions, formats, concepts, insights, solutions, functions, strategies, patterns, etc)
program configuration (data sources, query & usage statistics, optimization configuration, prior queries & related objects)

One skilled in the art, after reviewing this disclosure, may recognize that modifications, additions, or omissions may be made to the system 100 without departing from the scope of the disclosure. For example, the operations of the system 100 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

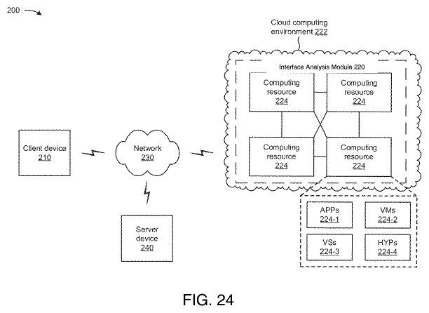

FIG. 24 is a diagram of an example environment 200 in which systems and/or methods, described herein, may be implemented. As shown in FIG. 24, environment 200 may include a client device 210, an interface analysis module 220, a network 230, and a server device 240. Devices of environment 200 may interconnect via wired connections, wireless connections, or a combination of wired and wireless connections.

Client device 210 includes one or more devices capable of receiving, generating, storing, processing, and/or providing information, such as information described herein. For example, client device 210 may include a mobile phone (e.g., a smart phone, a radiotelephone, etc.), a laptop computer, a tablet computer, a desktop computer, a handheld computer, a gaming device, a wearable communication device (e.g., a smart wristwatch, a pair of smart eyeglasses, etc.), or a similar type of device. In some implementations, client device 210 may receive information from and/or transmit information to interface analysis module 220 and/or server device 240.

Interface analysis module 220 includes one or more devices that utilize machine learning models to predict a variable (e.g., provided by server device 240 to client device 210). In some implementations, interface analysis module 220 may be designed to be modular such that certain software components may be swapped in or out depending on a particular need. As such, interface analysis module 220 may be easily and/or quickly reconfigured for different uses. In some implementations, interface analysis module 220 may receive information from and/or transmit information to one or more client devices 210 and/or server devices 240.

In some implementations, as shown, interface analysis module 220 may be hosted in a cloud computing environment 222. Notably, while implementations described herein describe interface analysis module 220 as being hosted in cloud computing environment 222, in some implementations, interface analysis module 220 may not be cloud-based (i.e., may be implemented outside of a cloud computing environment) or may be partially cloud-based.

Cloud computing environment 222 includes an environment that hosts interface analysis module 220. Cloud computing environment 222 may provide computation, software, data access, storage, etc. services that do not require end-user knowledge of a physical location and configuration of system(s) and/or device(s) that hosts interface analysis module 220. As shown, cloud computing environment 222 may include a group of computing resources 224 (referred to collectively as “computing resources 224” and individually as “computing resource 224”).

Computing resource 224 includes one or more personal computers, workstation computers, server devices, or other types of computation and/or communication devices. In some implementations, computing resource 224 may host interface analysis module 220. The cloud resources may include compute instances executing in computing resource 224, storage devices provided in computing resource 224, data transfer devices provided by computing resource 224, etc. In some implementations, computing resource 224 may communicate with other computing resources 224 via wired connections, wireless connections, or a combination of wired and wireless connections.

As further shown in FIG. 24, computing resource 224 includes a group of cloud resources, such as one or more applications (“APPs”) 224-1, one or more virtual machines (“VMs”) 224-2, virtualized storage (“VSs”) 224-3, one or more hypervisors (“HYPs”) 224-4, and/or the like.

Application 224-1 includes one or more software applications that may be provided to or accessed by client device 210 and/or server device 240. Application 224-1 may eliminate a need to install and execute the software applications on client device 210 and/or server device 240. For example, application 224-1 may include software associated with interface analysis module 220 and/or any other software capable of being provided via cloud computing environment 222. In some implementations, one application 224-1 may send/receive information to/from one or more other applications 224-1, via virtual machine 224-2.

Virtual machine 224-2 includes a software implementation of a machine (e.g., a computer) that executes programs like a physical machine. Virtual machine 224-2 may be either a system virtual machine or a process virtual machine, depending upon use and degree of correspondence to any real machine by virtual machine 224-2. A system virtual machine may provide a complete system platform that supports execution of a complete operating system (“OS”). A process virtual machine may execute a single program, and may support a single process. In some implementations, virtual machine 224-2 may execute on behalf of a user (e.g., a user of client device 210 and/or server device 240, or an operator of interface analysis module 220), and may manage infrastructure of cloud computing environment 222, such as data management, synchronization, or long-duration data transfers.

Virtualized storage 224-3 includes one or more storage systems and/or one or more devices that use virtualization techniques within the storage systems or devices of computing resource 224. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 224-4 may provide hardware virtualization techniques that allow multiple operating systems (e.g., “guest operating systems”) to execute concurrently on a host computer, such as computing resource 224. Hypervisor 224-4 may present a virtual operating platform to the guest operating systems, and may manage the execution of the guest operating systems. Multiple instances of a variety of operating systems may share virtualized hardware resources.

Network 230 includes one or more wired and/or wireless networks. For example, network 230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or the like, and/or a combination of these or other types of networks.

Server device 240 includes one or more devices capable of receiving, generating, storing, processing, and/or providing information, such as information described herein. For example, server device 240 may include a laptop computer, a tablet computer, a desktop computer, a server device, a group of server devices, or a similar type of device, that provides a social media application for access by client device 210. In some implementations, server device may receive information from and/or transmit information to client device 210 and/or interface analysis module 220.

The number and arrangement of devices and networks shown in FIG. 24 are provided as an example. In practice, there may be additional devices and/or networks, fewer devices and/or networks, different devices and/or networks, or differently arranged devices and/or networks than those shown in FIG. 24. Furthermore, two or more devices shown in FIG. 24 may be implemented within a single device, or a single device shown in FIG. 24 may be implemented as multiple, distributed devices. Additionally, or alternatively, a set of devices (e.g., one or more devices) of environment 200 may perform one or more functions described as being performed by another set of devices of environment 200.

One skilled in the art, after reviewing this disclosure, may recognize that modifications, additions, or omissions may be made to the environment 200 without departing from the scope of the disclosure. For example, the operations of the process 200 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

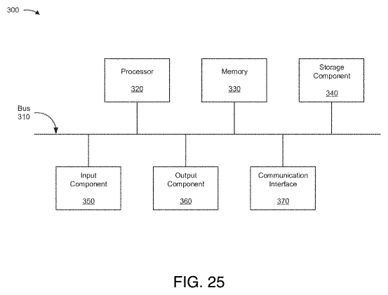

FIG. 25 is a diagram of example components of a device 300. Device 300 may correspond to client device 210, interface analysis module 220, computing resource 224, and/or server device 240. In some implementations, client device 210, interface analysis module 220, computing resource 224, and/or server device 240 may include one or more devices 300 and/or one or more components of device 300. As shown in FIG. 25, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, and/or the like.

Device 300 may perform one or more processes described herein. Device 300 may perform these processes based on processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 25 are provided as an example. In practice, device 300 may include additional components, fewer components, different components, or differently arranged components than those shown in FIG. 25. Additionally, or alternatively, a set of components (e.g., one or more components) of device 300 may perform one or more functions described as being performed by another set of components of device 300.

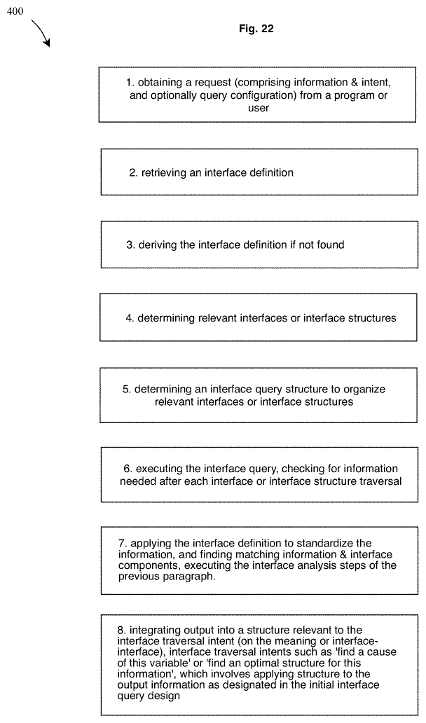

As further shown in FIG. 22, process 400 may include utilizing a machine learning model to predict a variable. For example, interface analysis module 220 (via computing resource 224, processor 320, memory 330, and/or the like) may utilize a machine learning model to predict a variable. In some implementations, the machine learning model used to predict a variable may include one or more of a decision tree learning model, a learning classifier systems model, a nearest neighbor model, a support vector machine model, a clustering model, a neural network model, a latent variable model, and/or the like.

A decision tree learning model may use a decision tree data structure to perform machine learning. A decision tree data structure classifies a population into branch-like segments that form an inverted tree with a root node, internal nodes, and leaf nodes. For example, the decision tree learning model may use a decision tree as a predictive model to map observations about an item (e.g., represented in the branches of the tree data structure) to conclusions about a target value of the item (e.g., represented in the leaves of the tree data structure). The process of building a decision tree may include partitioning the data set into subsets, shortening branches of the tree, and selecting a tree (e.g., the smallest tree) that fits the data. In some implementations, a decision tree model may be a classification tree (e.g., where the target variable can take a discrete set of values) in which leaves represent class labels and branches represent conjunctions of features that lead to those class labels. Alternatively, a decision tree model may be a regression tree (e.g., where the target variable can take continuous values, such as real numbers).

A learning classifier systems model may use learning classifier systems to perform machine learning. Learning classifier systems are a paradigm of rule-based machine learning methods that combine a discovery component (e.g. typically a genetic algorithm) with a learning component (e.g., performing either supervised learning, reinforcement learning, or unsupervised learning). Learning classifier systems seek to identify a set of context-dependent rules that collectively store and apply knowledge in a piecewise manner in order to perform functions such as classification, regression, data mining, and/or the like. Learning classifier systems allow complex solution spaces to be broken up into smaller, simpler parts.

A nearest neighbor model may use a k-nearest neighbors model to perform machine learning (e.g., pattern recognition). A k-nearest neighbors model is a non-parametric method that may be used for classification (e.g., where the output is a class membership) in which an object is classified by a majority vote of its neighbors, with the object being assigned to the class most common among its k nearest neighbors, or may be used for regression (e.g., where the output is a property value for the object) in which the value is the average of the values of its k nearest neighbors. Additionally, weights may be assigned to the contributions of the neighbors, so that the nearer neighbors contribute more to the average of the values than the more distant neighbors.

A support vector machine model may use a support vector machine (also known as a support vector network) to perform machine learning. A support vector machine is a supervised learning model with associated learning algorithms that analyze data used for classification and regression analysis. Given a set of training examples, each marked as belonging to one or the other of two categories, a support vector machine training algorithm builds a model that assigns new examples to one category or the other. A support vector machine model represents examples as points in space that are mapped so that the examples of separate categories are divided by a clear gap. New examples are then mapped into that same space and predicted to belong to a category based on which side of the gap they fall.

A clustering model may use cluster analysis (also known as clustering) to perform machine learning. Cluster analysis is the task of grouping a set of objects in such a way that objects in the same group (called a cluster) are more similar to each other than to objects in other groups. Cluster analysis can be achieved by various methods that differ significantly in their notion of what constitutes a cluster and how to efficiently find them. Different cluster models may include connectivity models (e.g., where hierarchical clustering builds models based on distance connectivity), centroid models (e.g., where the k-means algorithm represents each cluster by a single mean vector), distribution models (e.g., where clusters are modeled using statistical distributions, such as multivariate normal distributions used by the expectation-maximization algorithm), density models (e.g., where clusters are defined as connected dense regions in the data space), and/or the like.

A neural network model may use an artificial neural network to perform machine learning. An artificial neural network utilizes a collection of connected units or nodes called artificial neurons. Each connection between artificial neurons can transmit a signal from one artificial neuron to another artificial neuron. The artificial neuron that receives the signal can process the signal and then provide a signal to artificial neurons connected to it. In some artificial neural network implementations, the signal at a connection between artificial neurons may be a real number, and the output of each artificial neuron may be calculated by a non-linear function of the sum of its inputs. Artificial neurons and connections typically have a weight that adjusts as learning proceeds. The weight may increase or decrease the strength of the signal at a connection. Additionally, an artificial neuron may have a threshold such that the artificial neuron may send a signal if the aggregate signal satisfies the threshold. Artificial neurons may be organized in layers, and different layers may perform different kinds of transformations on their inputs.

A latent variable model may use latent variables (e.g., variables that are inferred rather than directly observed) to perform machine learning. A latent variable model may infer the latent variables (e.g., through a mathematical model) from other variables that are observed (e.g., directly measured). In some cases, latent variables may correspond to aspects of physical reality that can be measured, but may not be measured for practical reasons. In such cases, latent variables may be referred to as hidden variables. In other cases, latent variables may correspond to abstract concepts, such as categories, behavioral or mental states, or data structures. In such cases, latent variables may be referred to as hypothetical variables or hypothetical constructs.

One skilled in the art, after reviewing this disclosure, may recognize that modifications, additions, or omissions may be made to the interface analysis module 140 without departing from the scope of the disclosure. For example, the designations of different elements in the manner described is meant to help explain concepts described herein and is not limiting. Further, the interface analysis module 140 may include any number of other elements or may be implemented within other systems or contexts than those described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and processes described herein are generally described as being implemented in software (stored on and/or executed by general purpose hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc. are not necessarily used herein to connote a specific order. Generally, the terms “first,” “second,” “third,” etc., are used to distinguish between different elements. Absence a showing of a specific that the terms “first,” “second,” “third,” etc. connote a specific order, these terms should not be understood to connote a specific order.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that various changes, substitutions, and alterations could be made hereto without departing from the spirit and scope of the present disclosure.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Certain user interfaces have been described herein and/or shown in the figures. A user interface may include a graphical user interface, a non-graphical user interface, a text-based user interface, or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

1. A method comprising:
1. obtaining a request (comprising information & intent, and optionally query configuration) from a program or user
2. retrieving an interface definition
3. deriving the interface definition if not found
4. determining relevant interfaces or interface structures
5. determining an interface query structure to organize relevant interfaces or interface structures
6. executing the interface query, checking for information needed after each interface or interface structure traversal
7. applying the interface definition to standardize the information, and finding matching information & interface components, executing the interface analysis steps of the previous paragraph.
8. integrating output into a structure relevant to the requested intent (on the meaning or interface-interface), which involves applying structure to the output information as designated in the interface query design.

2. The method of claim 1, wherein obtaining input information from a program or user (like a data set of possibly related variables, or objects in a relational database) involves receiving as input:
a supported intent (such as ‘find a cause of this variable in the data set’ or ‘find an optimal structure for this information’)
information to fulfill that intent (like an API description, data set, or document).

3. The method of claim 1, wherein retrieving an interface definition involves querying the database which stores information objects including definitions (as well as other interface components, like interface-specific functions).

4. The method of claim 1, wherein deriving the interface definition (if not found) involves applying logic like ‘searching for examples of the interface on other interfaces’, ‘aggregating unhandled variance into the new interface as a potential change type formattable on that interface’, ‘filtering examples of an interface into core components, which can be used to generate the examples’ or ‘assuming common core components & patterns for the interface from other interfaces and applying distortion functions until the interface examples can be generated’.

5. The method of claim 1, wherein determining relevant interfaces or interface structures involves executing logic like evaluating whether an interface would frame the input information in a way that maximizes differences within the information, while fulfilling metrics like ‘avoiding losing relevant information’ or ‘avoiding unnecessary complexity’.

6. The method of claim 1, wherein determining an interface query structure to organize relevant interface structures involves assembling a structure (like a network) to connect interface structures (like an interface) into a format that will connect the input information format with the output information format given in the user-supplied intent.

7. The method of claim 1, wherein executing the interface query involves navigating the structure of the interface query, a structure such as a network with logical operations like conditions & exit or return statements to connect interface structures (like combined interfaces, interface traversals, or interfaces).

8. The method of claim 1, wherein applying the interface definition to standardize the information, and finding matching information & interface components.
1. convert input information to interface based on interface object definition (remove information unrelated to dependencies for the causal interface)
2. apply an interface to input information (find core causal interface components (like structures, such as directions of dependency) in the input information necessary to do other causal interface operations)
3. apply interface components to distort information to generate additional information to match (distort input information with causal or other interface components)
specific interface components (like navigation functions) for that interface
core/common components (like distortion functions) of that interface
related components of the interface
other interfaces/interface operations
4. find matching objects (check formatted information & distorted information for objects that match the causal interface objects
5. convert to input information format (integrate causal structures found with the input information, checking for validity of the structures & their related objects once integrated with the input information).

9. The method of claim 1, further comprising integrating output into a structure relevant to the requested intent (on the meaning or interface-interface), which involves applying structure to the output information as designated in the interface query design.

10. A non-transitory computer-readable medium containing instructions that, when executed by a processor, cause a device to perform operations, the operations comprising:
1. obtaining a request (comprising information & intent, and optionally query configuration) from a program or user
2. retrieving an interface definition
3. deriving the interface definition if not found
4. determining relevant interfaces or interface structures
5. determining an interface query structure to organize relevant interfaces or interface structures
6. executing the interface query, checking for information needed after each interface or interface structure traversal
7. applying the interface definition to standardize the information, and finding matching information & interface components, executing the interface analysis steps of the previous paragraph.
8. integrating output into a structure relevant to the requested intent (on the meaning or interface-interface), which involves applying structure to the output information as designated in the interface query design.

11. The non-transitory computer-readable medium of claim 10, wherein obtaining input information from a program or user (like a data set of possibly related variables, or objects in a relational database) involves receiving as input:
a supported intent (such as ‘find a cause of this variable in the data set’ or ‘find an optimal structure for this information’)
information to fulfill that intent (like an API description, data set, or document).

12. The non-transitory computer-readable medium of claim 10, wherein retrieving an interface definition involves querying the database which stores information objects including definitions (as well as other interface components, like interface-specific functions).

13. The non-transitory computer-readable medium of claim 10, wherein deriving the interface definition (if not found) involves applying logic like ‘searching for examples of the interface on other interfaces’, ‘aggregating unhandled variance into the new interface as a potential change type formattable on that interface’, ‘filtering examples of an interface into core components, which can be used to generate the examples’ or ‘assuming common core components & patterns for the interface from other interfaces and applying distortion functions until the interface examples can be generated’.

14. The non-transitory computer-readable medium of claim 10, wherein determining relevant interfaces or interface structures involves executing logic like evaluating whether an interface would frame the input information in a way that maximizes differences within the information, while fulfilling metrics like ‘avoiding losing relevant information’ or ‘avoiding unnecessary complexity’.

15. The non-transitory computer-readable medium of claim 10, wherein determining an interface query structure to organize relevant interface structures involves assembling a structure (like a network) to connect interface structures (like an interface) into a format that will connect the input information format with the output information format given in the user-supplied intent.

16. The non-transitory computer-readable medium of claim 10, wherein executing the interface query involves navigating the structure of the interface query, a structure such as a network with logical operations like conditions & exit or return statements to connect interface structures (like combined interfaces, interface traversals, or interfaces).

17. The non-transitory computer-readable medium of claim 10, wherein applying the interface definition to standardize the information, and finding matching information & interface components.
1. convert input information to interface based on interface object definition (remove information unrelated to dependencies for the causal interface)
2. apply an interface to input information (find core causal interface components (like structures, such as directions of dependency) in the input information necessary to do other causal interface operations)
3. apply interface components to distort information to generate additional information to match (distort input information with causal or other interface components)
specific interface components (like navigation functions) for that interface
core/common components (like distortion functions) of that interface
related components of the interface
other interfaces/interface operations
4. find matching objects (check formatted information & distorted information for objects that match the causal interface objects
5. convert to input information format (integrate causal structures found with the input information, checking for validity of the structures & their related objects once integrated with the input information).

18. The non-transitory computer-readable medium of claim 10, the operations further comprising integrating output into a structure relevant to the requested intent (on the meaning or interface-interface), which involves applying structure to the output information as designated in the interface query design.

19. A system comprising: one or more processors; and one or more non-transitory computer-readable media containing instructions that, when executed by the one or more processors, cause the system to perform operations, the operations comprising:
1. obtaining a request (comprising information & intent, and optionally query configuration) from a program or user
2. retrieving an interface definition
3. deriving the interface definition if not found
4. determining relevant interfaces or interface structures
5. determining an interface query structure to organize relevant interfaces or interface structures
6. executing the interface query, checking for information needed after each interface or interface structure traversal
7. applying the interface definition to standardize the information, and finding matching information & interface components, executing the interface analysis steps of the previous paragraph.
8. integrating output into a structure relevant to the requested intent (on the meaning or interface-interface), which involves applying structure to the output information as designated in the interface query design.

20. The system of claim 19, wherein obtaining input information from a program or user (like a data set of possibly related variables, or objects in a relational database) involves receiving as input:
a supported intent (such as ‘find a cause of this variable in the data set’ or ‘find an optimal structure for this information’)
information to fulfill that intent (like an API description, data set, or document).

21. The system of claim 19, wherein retrieving an interface definition involves querying the database which stores information objects including definitions (as well as other interface components, like interface-specific functions).

22. The system of claim 19, wherein deriving the interface definition (if not found) involves applying logic like ‘searching for examples of the interface on other interfaces’, ‘aggregating unhandled variance into the new interface as a potential change type formattable on that interface’, ‘filtering examples of an interface into core components, which can be used to generate the examples’ or ‘assuming common core components & patterns for the interface from other interfaces and applying distortion functions until the interface examples can be generated’.

23. The system of claim 19, wherein determining relevant interfaces or interface structures involves executing logic like evaluating whether an interface would frame the input information in a way that maximizes differences within the information, while fulfilling metrics like ‘avoiding losing relevant information’ or ‘avoiding unnecessary complexity’.

24. The system of claim 19, wherein determining an interface query structure to organize relevant interface structures involves assembling a structure (like a network) to connect interface structures (like an interface) into a format that will connect the input information format with the output information format given in the user-supplied intent.

25. The system of claim 19, wherein executing the interface query involves navigating the structure of the interface query, a structure such as a network with logical operations like conditions & exit or return statements to connect interface structures (like combined interfaces, interface traversals, or interfaces).

26. The system of claim 19, wherein applying the interface definition to standardize the information, and finding matching information & interface components.
1. convert input information to interface based on interface object definition (remove information unrelated to dependencies for the causal interface)
2. apply an interface to input information (find core causal interface components (like structures, such as directions of dependency) in the input information necessary to do other causal interface operations)
3. apply interface components to distort information to generate additional information to match (distort input information with causal or other interface components)
specific interface components (like navigation functions) for that interface
core/common components (like distortion functions) of that interface
related components of the interface
other interfaces/interface operations
4. find matching objects (check formatted information & distorted information for objects that match the causal interface objects
5. convert to input information format (integrate causal structures found with the input information, checking for validity of the structures & their related objects once integrated with the input information)

27. The system of claim 19, further comprising integrating output into a structure relevant to the requested intent (on the meaning or interface-interface), which involves applying structure to the output information as designated in the interface query design.
